(19) United States
(12) Patent Application Publication
(10) Pub. No.: US 2014/0240362 A1
(43) Pub. Date: Aug. 28, 2014

(54) Method for Processing and Displaying Image Information, Program, and Information Processor

(71) Applicant: Semiconductor Energy Laboratory Co., Ltd., Kanagawa-ken (JP)

(72) Inventor: Keiichi Kurita, Atsugi (JP)

(73) Assignee: Semiconductor Energy Laboratory Co., Ltd., Kanagawa-ken (JP)

(21) Appl. No.: 14/192,108

(22) Filed: Feb. 27, 2014

(30) Foreign Application Priority Data
Feb. 28, 2013 (JP) 2013-038218

(51) Int. Cl. G09G 5/373

(52) U.S. Cl. CPC G09G 5/373
USPC 345/661

(57) ABSTRACT

A method for displaying image information, the method including a step of specifying a character string which a user tries to distinguish among character strings displayed on a display portion and a step of enlarging and displaying the character string.

### BACKGROUND OF THE INVENTION

1. Field of the Invention

The present invention relates to an object, a method, or a manufacturing method. In addition, the present invention relates to a process, a machine, manufacture, or a composition of matter. In particular, the present invention relates to, for example, a semiconductor device, a display device, a light-emitting device, a power storage device, a driving method thereof, or a manufacturing method thereof. In particular, the present invention relates to, for example, a method and a program for processing and displaying image information, and a device including a recording medium in which the program is recorded. In particular, the present invention relates to, for example, a method for processing and displaying image information by which an image including information processed by an information processor provided with a display portion is displayed, a program for displaying an image including information processed by an information processor provided with a display portion, and an information processor including a recording medium in which the program is recorded.

2. Description of the Related Art

A technique for reducing power consumption is known in which a refresh rate is reduced when a still image is displayed on a display portion.

### REFERENCE

### [Patent Document 1] Japanese Published Patent Application No. 2011-186449

### SUMMARY OF THE INVENTION

An information processor processes inputted information and outputs the processed information to an output device such a display portion. Note that in general, a display portion includes a pixel region in which a plurality of pixels is arranged.

In the information processor, rewriting (refreshing) of an image displayed on a display region is performed at a frequency higher than 60 Hz, for example, whereby a still image or a moving image is displayed on a pixel region.

When a user uses the information processor for a long time, the user watches an image displayed on a display portion for a long time, which puts strain the user's eyes, so that the user feels fatigue.

One embodiment of the present invention is made in view of the foregoing technical background. One object of one embodiment of the present invention is to provide a novel method for processing and displaying image information. Another object is to provide a novel program and a novel information processor.

Note that the descriptions of these objects do not disturb the existence of other objects. In one embodiment of the present invention, there is no need to achieve all the objects. Other objects will be apparent from and can be derived from the description of the specification, the drawings, the claims, and the like.

One embodiment of the present invention is a method for processing and displaying image information including a first step of displaying image information including a character string on a display portion which includes a plurality of pixels with a resolution of 150 ppi or more and which is capable of eye-friendly display by using light with a wavelength greater than or equal to 420 nm; a second step of selecting a first region including a character string; a third step of enlarging and displaying the character string in a second region which is larger than the first region; a fourth step of bringing the first region into a non-selected state; and a fifth step of erasing display of the character string from the second region and completing a process.

Further, one embodiment of the present invention is the method for processing and displaying image information, in which in the second step, the first region including the character string, a row to which the character string belongs, and rows before and after the row is selected.

Further, one embodiment of the present invention is the method for processing and displaying image information, in which in the third step, the second region is provided so as to partly overlap with or be adjacent to the first region.

The method for processing and displaying image information, which is one embodiment of the present invention, includes a step of specifying a character string which a user tries to distinguish and a step of enlarging and displaying the character string. Accordingly, without losing browsability of information, a character string with size in accordance with accommodation ability of an eye of a user can be displayed on a display portion of an information processor. As a result, a novel method for processing and displaying image information can be provided.

Further, one embodiment of the present invention is the method for processing and displaying image information, in which in the fourth step, the first region is brought into a non-selected state by selection of a region other than the first region and the second region.

The method for processing and displaying image information, which is one embodiment of the present invention, includes a step of opening the first region including a portion which a user tries to distinguish by selecting of a region other than the first region and the second region. Accordingly, the frequency of occurrence of operation errors in that enlarged display is completed by mistake while the user identifies a character string included in the first region, for example, can be reduced. As a result, a novel method for processing and displaying image information, which is excellent in operability, can be provided.

Further, one embodiment of the present invention is the method for processing and displaying image information including a first step of displaying image information including a character string on a display portion which includes a plurality of pixels with a resolution of 150 ppi or more and which is capable of eye-friendly display by using light with a wavelength greater than or equal to 420 nm; a second step of specifying one user in accordance with positions of users with respect to the display portion; a third step of selecting a first region including a character string by using a sight line of the user; a fourth step of enlarging and displaying the character string in a second region which is larger than the first region; a fifth step of bringing the first region into a non-selected state; and a sixth step of erasing display of the character string from the second region and completing a process.

The method for processing and displaying image information, which is one embodiment of the present invention, includes a step of specifying one user in accordance with positions of users with respect to a display portion, a step of specifying a character string which the user tries to distinguish, and a step of enlarging and displaying the character string. Accordingly, without losing browsability of information, a character string with a size in accordance with accommodation ability of an eye of a user can be displayed on a display portion of an information processor by one user specified from a plurality of users. As a result, a novel method for processing and displaying image information can be provided.

Further, one embodiment of the present invention is a program for making an information processor execute a process the information processor including an arithmetic unit, an input unit, and a display portion which includes a plurality of pixels for displaying information processed in the arithmetic unit at a resolution of 150 ppi or more and which is capable of eye-friendly display by using light with a wavelength greater than or equal to 420 nm, the process including a first step of displaying image information including a character string on the display portion; a second step of selecting a first region including a character string; a third step of enlarging and displaying the character string in a second region which is larger than the first region; a fourth step of bringing the first region into a non-selected state; and a fifth step of erasing display of the character string from the second region and completing a process.

The program for processing and displaying image information, which is one embodiment of the present invention, includes a step of specifying a character string which a user tries to distinguish and a step of enlarging and displaying the character string. Accordingly, without losing browsability of information, a character string with a size in accordance with accommodation ability of an eye of a user can be displayed on a display portion of an information processor. As a result, a novel program for processing and displaying image information can be provided.

Further, one embodiment of the present invention is an information processor including an arithmetic unit; an input unit for inputting information to the arithmetic unit; a display portion which includes a plurality of pixels for displaying information processed in the arithmetic unit at a resolution of 150 ppi or more and which is capable of eye-friendly display by using light with a wavelength greater than or equal to 420 nm; and a storage unit which stores a program executed by the arithmetic unit. The program makes the arithmetic unit execute a process including a first step of displaying image information including a character string on the display portion; a second step of selecting a first region including a character string; a third step of enlarging and displaying the character string in a second region which is larger than the first region; a fourth step of bringing the first region into a non-selected state; and a fifth step of erasing display of the character string from the second region and completing a process.

The information processor, which is one embodiment of the present invention, includes an arithmetic unit which performs a step of specifying a character string which a user tries to distinguish and a step of enlarging and displaying the character string. Accordingly, without losing browsability of information, a character string with a size in accordance with accommodation ability of an eye of a user can be displayed on a display portion of an information processor. As a result, a novel information processor for processing and displaying image information can be provided.

Although the block diagram attached to this specification shows components classified by their functions in independent blocks, it is difficult to classify actual components according to their functions completely and it is possible for one component to have a plurality of functions.

In this specification, the terms “source” and “drain” of a transistor interchange with each other depending on the polarity of the transistor or the levels of potentials applied to the terminals. In general, in an n-channel transistor, a terminal to which a lower potential is applied is called a source, and a terminal to which a higher potential is applied is called a drain. Further, in a p-channel transistor, a terminal to which a lower potential is applied is called a drain, and a terminal to which a higher potential is applied is called a source. In this specification, although connection relation of the transistor is described assuming that the source and the drain are fixed in some cases for convenience, actually, the names of the source and the drain interchange with each other depending on the relation of the potentials.

Note that in this specification, a “source” of a transistor means a source region that is part of a semiconductor film functioning as an active layer or a source electrode connected to the semiconductor film. Similarly, a “drain” of the transistor means a drain region that is part of the semiconductor film or a drain electrode connected to the semiconductor film. A “gate” means a gate electrode.

Note that in this specification, a state in which transistors are connected to each other in series means, for example, a state in which only one of a source and a drain of a first transistor is connected to only one of a source and a drain of a second transistor. In addition, a state in which transistors are connected to each other in parallel means a state in which one of a source and a drain of a first transistor is connected to one of a source and a drain of a second transistor and the other of the source and the drain of the first transistor is connected to the other of the source and the drain of the second transistor.

In this specification, the term “connection” means electrical connection and corresponds to a state where current, voltage, or a potential can be supplied or transmitted. Accordingly, a connection state means not only a state of direct connection but also a state of indirect connection through a circuit element such as a wiring, a resistor, a diode, or a transistor so that current, voltage, or a potential can be supplied or transmitted.

In this specification, even when different components are connected to each other in a circuit diagram, there is actually a case where one conductive film has functions of a plurality of components such as a case where part of a wiring serves as an electrode. The tem′ “connection” also means such a case where one conductive film has functions of a plurality of components.

Further, in this specification, one of a first electrode and a second electrode of a transistor refers to a source electrode and the other refers to a drain electrode.

According to one embodiment of the present invention, a novel method for processing and displaying image information can be provided. Further, a novel program for processing and displaying image information can be provided. Furthermore, a novel information processor capable of processing and displaying image information can be provided.

### BRIEF DESCRIPTION OF THE DRAWINGS

FIG. 1A is a block diagram illustrating an information processor capable of employing a method for processing and displaying image information according to one embodiment, and FIGS. 1B and 1C each illustrate a method for using an information processor.

FIG. 2 is a flow chart illustrating a method for processing and displaying image information according to one embodiment.

FIGS. 3A to 3C are each a flow chart illustrating a method for processing and displaying image information according to one embodiment.

FIG. 4 is a flow chart illustrating a method for processing and displaying image information according to one embodiment.

FIGS. 5A1, 5A2, 5B1, and 5B2 illustrate an effect of a method for processing and displaying image information according to one embodiment.

FIG. 6A is a block diagram illustrating a structure of an information processor capable of employing an information processing method according to one embodiment and FIG. 6B illustrates a state in which an image is changed.

FIG. 7 is a block diagram illustrating a structure of an information processor with a display function according to one embodiment.

FIGS. 8A1, 8A2, 8B1, and 8B2 are block diagrams and circuit diagrams illustrating a structure of a display portion in a display device according to one embodiment.

FIGS. 9A and 9B illustrate a structural example of a transistor according to one embodiment.

FIGS. 10A to 10D illustrate an example of a method for manufacturing a transistor according to one embodiment.

FIGS. 11A and 11B each illustrate a structural example of a transistor according to one embodiment.

FIGS. 12A to 12C each illustrate a structural example of a transistor according to one embodiment.

FIGS. 13A and 13B are schematic perspective views of a touch panel according to one embodiment.

FIG. 14 is a cross-sectional view of a touch panel according to one embodiment.

FIGS. 15A to 15C each illustrate an electronic device according to one embodiment.

### DETAILED DESCRIPTION OF THE INVENTION

### Example of Problem Solvable by One Embodiment of the Present Invention

With improvement in processing capability of an information processor, the information processor can supply an enormous amount of information to a display portion while keeping browsability.

Further, as performance of a display device is improved, a display portion which has a large screen or/and high resolution can be more easily applied to an information processor.

Although performance of an information processor is improved as described above, there is a limitation on accommodation ability of human eyes. An image displayed at high resolution beyond the limitation of a user of an information processor is not easily distinguished or cannot be distinguished.

When a user of an information processor watches an image which is not easily distinguished for a long time, strain put on the eyes is increased, so that the user feels fatigue in some times. Note that the accommodation ability of eyes reduces with increasing age or the like and varies among individuals.

### <Eye Fatigue>

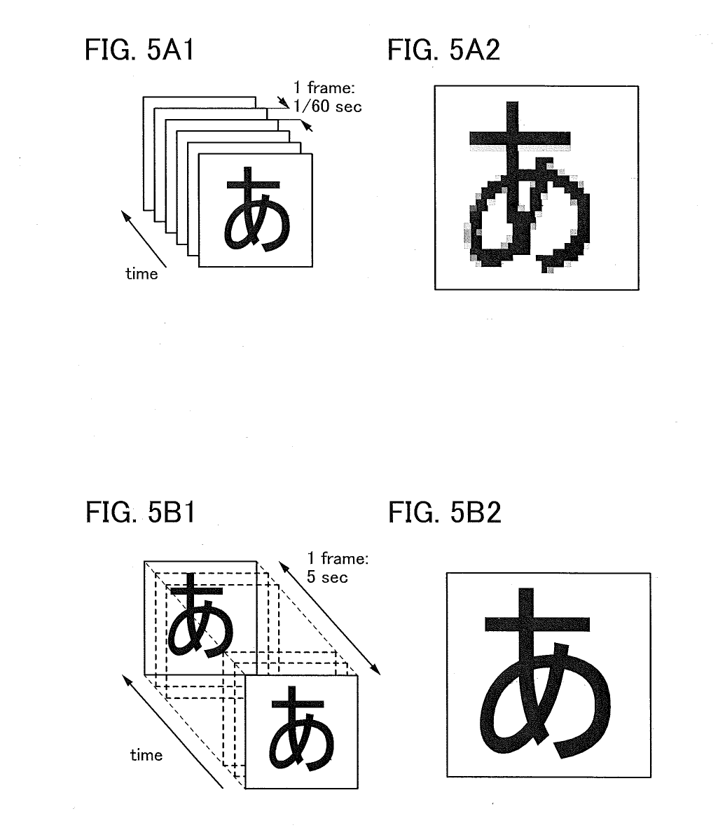

Eye fatigue is classified into two categories: nervous asthenopia and muscular asthenopia. The eye fatigue is explained using the schematic views of FIGS. 5A1 and 5A2.

### <<Nervous Asthenopia>>

Nervous asthenopia is caused when a user keeps looking at continuous or blinking light emitted from a display portion for a long time. This is because the brightness stimulates and fatigues the retina or nerve of the eye or the brain. Frequent blinking of fluorescent light or a display portion of a conventional display device, which is called flicker, causes nervous asthenopia.

The muscle strain is caused by overuse of a ciliary muscle which works for adjusting the focus.

FIG. 5A1 is a schematic view showing display on a conventional display portion. An image is rewritten 60 times per second in display on the conventional display portion. When a user keeps looking at such display for a long time, the retina or nerve of the eye or the brain may be stimulated and eye fatigue might be caused as a result.

### <<Muscle Asthenopia>>

In addition, as shown in FIG. 5A2, when the size of each pixel is large (for example, when the resolution is less than 150 ppi), the outline of a character or the like displayed on the display portion is blurred. When a user keeps looking at the character or the like with a blurred outline displayed on the display portion for a long time, it remains difficult to focus the eye on the character even though the ciliary muscle constantly moves in order to focus the eye, which might put strain on the eye.

Further, when a user of an information processor watches an image displayed at high resolution beyond the limitation of the user for a long time, strain put on the eyes is increased in some cases.

### <<Quantitative Measurement of Eye Fatigue>>

Quantitative measurement of eye fatigue has been studied. For example, critical flicker (fusion) frequency (CFF) is known as an indicator for evaluating nervous asthenopia. Further, accommodation time, near point distance, and the like are known as indicators for evaluating muscular asthenopia.

Other methods for evaluating eye fatigue include electroencephalography, thermography, counting the number of times of blinking, measuring the amount of tears, measuring the speed of contractile response of the pupil, and questionnaires for surveying subjective symptoms.

### One Embodiment of Present Invention

In order to achieve the above object, one embodiment of the present invention focuses on the size of a character displayed on a display portion of an information processor.

The embodiments described below include one embodiment of the present invention which is made by focusing on the size of a character in a portion which a user tries to distinguish of characters displayed on a display portion of an information processor.

The method for processing and displaying image information, which is one embodiment of the present invention, includes a step of specifying a character string which a user tries to distinguish and a step of enlarging and displaying the character string. Accordingly, without losing browsability of information, a character with a size in accordance with accommodation ability of an eye of a user can be displayed on a display portion of an information processor. As a result, a novel method for processing and displaying image information can be provided. Further, a novel program for processing and displaying image information can be provided. Furthermore, a novel information processor capable of processing and displaying image information can be provided.

### <Information Processor>

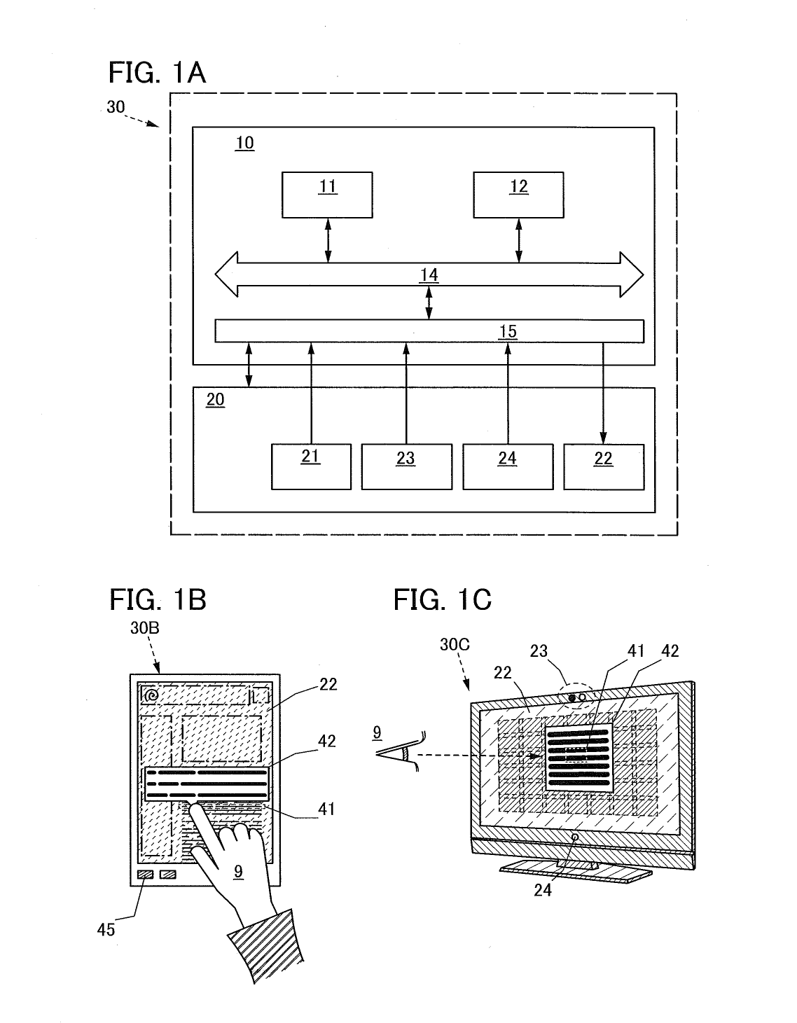

FIG. 1A shows an example of a block diagram of an information processor capable of employing the method for processing and displaying image information, which is one embodiment of the present invention.

An information processor 30 includes an arithmetic unit 11, a storage unit 12, and a transmission path 14. The transmission path 14 connects the arithmetic unit 11, the storage unit 12, and an input/output interface 15 to each other and transmits information. Note that these components cannot be clearly distinguished and one component also serves as another component or includes part of another component in some cases. For example, a touch panel is an input unit as well as a display portion.

### <<Input/Output Device>>

An input/output device 20 is connected to the transmission path 14 via the input/output interface 15. The input/output device 20 is a device for inputting information to an arithmetic device 10 from the outside or outputting information to the outside from the arithmetic device 10.

Examples of the input/output device 20 include a communication device, a network connection device, and a writable external memory device such as a hard disk or a removable memory.

Examples of an input unit 21 include a human interface device such as a keyboard, a pointing device (e.g., a mouse), or a touch panel, a camera such as a digital camera or a digital video camera, a scanner, and a read-only external memory device such as a CD-ROM or a DVD-ROM. For example, a user of the information processor 30 can select a region including a character string or can input a page turning instruction or the like with the use of the input unit 21.

The information processor 30 of one embodiment of the present invention may be provided with a sight line detector 23 for detecting a sight line of a user or a distance sensor 24.

A display portion 22, a speaker, a printer, and the like can be connected as the output device.

### <<Display Portion>>

The information processor 30 of one embodiment of the present invention includes the display portion 22. In particular, display light of the display portion 22 does not include light with a wavelength shorter than 420 nm, preferably shorter than 440 nm. A display portion includes a plurality of pixels with a resolution of 150 ppi or more, preferably 200 ppi or more. This enables eye-friendly display. Note that in this specification, the display light refers to light emitted from or reflected on a display portion of an information processor so that a user can see displayed images.

The display light of the display portion of one embodiment of the present invention is not absorbed by the cornea and lens of the eye and reaches the retina, and therefore does not include light having long-term effects on the retina or adverse effects on the circadian rhythm. Specifically, light for displaying images does not include light with a wavelength of 400 nm or shorter, preferably 420 nm or shorter, more preferably 440 nm or shorter (such light is also referred to as UVA).

In addition, the display portion of one embodiment of the present invention includes pixels with a resolution of 150 ppi or more, preferably 200 ppi or more, that is, each pixel has a small size. This allows muscular asthenopia of the user's eyes to be reduced.

FIGS. 5B1 and 5B2 show schematic views illustrating an effect of reducing the eye fatigue in the information processor of one embodiment of the present invention.

In the information processor of one embodiment of the present invention, the rate at which a signal for selecting a pixel is output can be changed. In particular, a transistor with extremely low off-state current is used in a pixel portion of a display portion; thus, frame frequency can be lowered while flicker is reduced. For example, an image can be rewritten as less frequently as once every five seconds. This enables the user to see the same one image, so that flickers on the screen perceived by the user are reduced. Thus, stimuli to the retina or nerve of the eye or the brain of the user are reduced, and nervous asthenopia is reduced accordingly (see FIG. 5B1).

Note that a transistor including an oxide semiconductor, particularly a transistor including a CAAC-OS is suitably used as a transistor with extremely low off-state current.

Each pixel in the information processor of one embodiment of the present invention has a small size. Specifically, resolution as high as 150 ppi or more, preferably 200 ppi or more can be achieved. It is also possible to display precise and smooth images with a clear outline, which allows ciliary muscles to adjust the focus more easily, and reduces muscular asthenopia of users (see FIG. 5B2). Note that resolution can be expressed by pixel density (pixel per inch (ppi)). Pixel density is the number of pixels per inch. A pixel is a unit composing an image.

Embodiments are described in detail with reference to drawings. Note that the present invention is not limited to the description below, and it is easily understood by those skilled in the art that various changes and modifications can be made without departing from the spirit and scope of the present invention. Therefore, the present invention should not be construed as being limited to the description of the embodiments below. Note that in the structures of the invention described below, the same portions or portions having similar functions are denoted by the same reference numerals in different drawings, and description of such portions is not repeated.

### Embodiment 1

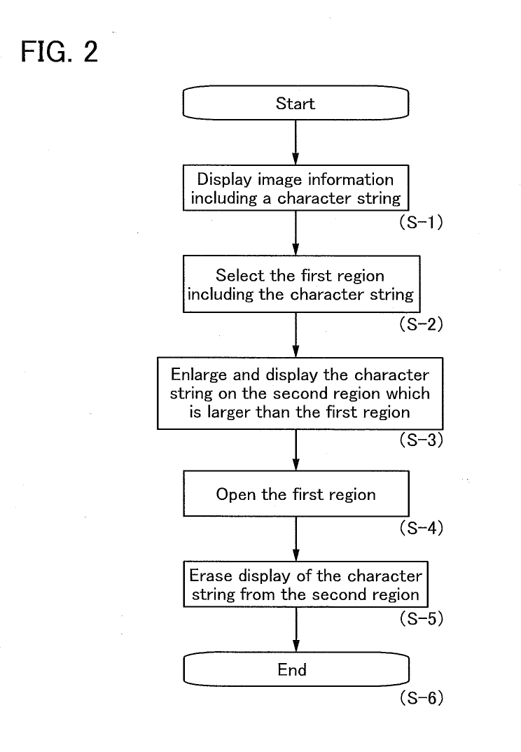

In this embodiment, a novel method for processing and displaying image information, which is one embodiment of the present invention, is described with reference to FIG. 2.

FIG. 2 is a flow chart showing the method for processing and displaying image information, which is one embodiment of the present invention. FIG. 1A shows an example of a block diagram of an information processor capable of employing the method for processing and displaying image information, which is one embodiment of the present invention.

The method for processing and displaying image information, which is described as an example in this embodiment, includes the following steps.

### <First Step>

In a first step, image information including a character string is displayed on a display portion 22 which includes a plurality of pixels with a resolution of 150 ppi or more and which is capable of eye-friendly display by using light which does not include light with a wavelength shorter than 420 nm (see FIG. 2 (S-1)).

The image information displayed includes a character string. Examples of the image information including a character string are a homepage published by the Internet or an intranet, an electronic document, and an electronic book.

### <Second Step>

In a second step, a first region including a character string is selected (see FIG. 2 (S-2)).

The first region including a character string is selected in the following manner, for example; coordinates are assigned in the display portion 22 in advance, and when a user inputs coordinates where a character string is displayed, the character string is specified.

As an input unit for inputting coordinates, for example, a touch panel or a sight line detector can be given.

For example, an information processor 30B illustrated in FIG. 1B as an example includes a touch panel in which an input unit 21 is incorporated in the display portion 22. Note that a region surrounded by a broken line in FIG. 1B schematically illustrates a photograph, a line drawing, or the like included in the image information. A bold solid line in FIG. 1B schematically illustrates a character string included in the image information.

When a user 9 points at a character string displayed on the touch panel with a finger, the coordinates where the character string is displayed can be inputted. An arithmetic unit 11 can specify the character string displayed at the inputted coordinates and a first region 41 including the character string.

Alternatively, the first region including a character string may be specified in the following manner: a button 45 for enlarging a character is provided in the information processor 30B and the user 9 points at a character string displayed on the touch panel with a finger while pushing the button 45 for enlarging a character. Further alternatively, the first region including a character string may be specified in the following manner: as soon as the user 9 touches a character string displayed on the touch panel, the user 9 moves a finger along the character string (e.g., within one second). Still further alternatively, the first region including a character string may be specified in the following manner: the user 9 draws a circle surrounding a character string with a finger or the like. An instruction is associated with a signal inputted from the touch panel in advance, whereby the operation for specifying the first region including a character string can be distinguished from other operations.

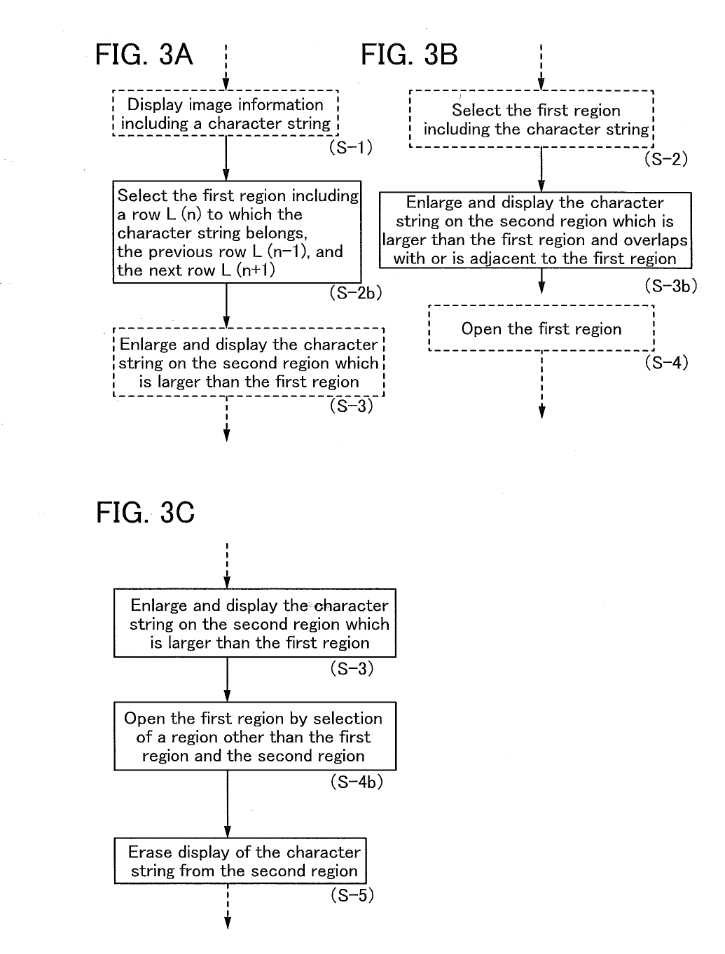

Alternatively, in the second step, the first region including a character string, a row to which the character string belongs, and rows before and after the row may be selected (see FIG. 3A (S-2b)).

Specifically, as the first region 41 including a character string, three rows in total consisting of a row L (n) including a character string at which the user 9 points with a finger, a row L (n−1) which is the previous row of the row L (n), and a row L (n+1) which is the next row of the row L (n) are selected (see FIG. 1B).

When the first region is selected in a row unit, a layout of the original image information can be reflected in a second region. In this manner, the user can perform an operation intuitively.

Note that in addition to a row unit, a word unit or a sentence unit can be used. Alternatively, when the first region is selected in a sentence unit, a structure of the sentence may be analyzed by the arithmetic unit and the sentence with a line break between elements may be displayed in the second region. This can help the user to understand a sentence having a complex structure.

For example, an information processor 30C illustrated in FIG. 1C as an example includes a display portion 22, a sight line detector 23, and a distance sensor 24. Note that a region in a matrix and a bold solid line in FIG. 1C schematically represent a chart and a character string, respectively. As an example of the chart, an image (e.g., an icon) for selecting a function of the information processor 30C, an image used to perform a function of a connected input/output device 20, or a program guide can be given.

When the user 9 watches a character string displayed on the display portion 22 carefully, the sight line is detected by the sight line detector 23 and the coordinates at which the sight line intersects with the display portion 22 is specified by the arithmetic unit, whereby the coordinates where the character string is displayed can be inputted. The arithmetic unit 11 can specify the character string displayed at the inputted coordinates and the first region 41 including the character string.

Specifically, as the first region 41 including a character string, a column including the character string which is carefully watched by the user 9 is selected.

Note that as a method for measuring the motion of an eyeball that can be used for the sight line detector 23, a corneal reflex method, a limbus tracking method, a search coil method, an electro oculography (BOG) method, and the like are known.

### <Third Step>

In a third step, the character string is enlarged and displayed in the second region which is larger than the first region (see FIG. 2 (S-3)).

The size of the second region is larger than that of the first region, whereby the character string included in the first region can be enlarged and displayed in the second region. Note that a plain image or the like may be used for a background of the character string so that the enlarged and displayed character string can be easily recognized. Further, the ratio of the size of the enlarged character to the size of the character displayed in the first region may be greater than 1 or the enlarged character may be a fixed size. Furthermore, the size of the enlarged character may be adjusted by the user or may be set in advance.

Further, in the third step, the second region may be provided so as to overlap with or be adjacent to the first region (see FIG. 3B (S-3b)).

For example, in the touch panel of the information processor 30B illustrated in FIG. 1B as an example, a second region 42 is displayed like a word balloon so as to be adjacent to the character string at which the user 9 points with a finger. The state in which the character string included in the first region 41 is enlarged and displayed in the second region 42 is schematically illustrated.

For example, on the display portion 22 of the information processor 30C illustrated in FIG. 1C, the second region 42 is displayed so as so overlap with the first region 41 including the character string which is carefully watched by the user 9. The state in which the character string included in the first region 41 is enlarged and displayed in the second region 42 is schematically illustrated.

### <Fourth Step>

In a fourth step, the first region is opened (see FIG. 2 (S-4)). Note that in this specification, the expression “the first region including a character string is opened or is brought into a non-selected state” means that the first region including a character string is brought from a selected state to an unselected state.

For example, the first region can be opened in the following manner: coordinates different from the coordinates that have been already inputted by the user is inputted.

For example, the user 9 of the information processor 30B illustrated in FIG. 1B as an example can input different coordinates by pointing at a different position on the touch panel with a finger. The arithmetic unit 11 opens the first region 41 in the case where different coordinates are inputted.

For example, the user 9 of the information processor 30C illustrated in FIG. 1C can input different coordinates by watching another place on the display portion 22 carefully. The arithmetic unit 11 opens the first region 41 in the case where different coordinates are inputted.

### <Fifth Step>

In a fifth step, display of the character string is erased from the second region and the flow is finished (see FIGS. 2 (S-5) and (S-6)).

For example, the displayed character string is erased from the second region 42 displayed like a word balloon on the touch panel of the information processor 30B illustrated in FIG. 1B as an example. Note that a plain image or the like used for a background of the character string is erased at the same time as erasure of the character string.

For example, the displayed character string is erased from the second region 42 displayed so as to overlap with the first region 41 in the display portion 22 of the information processor 30C illustrated in FIG. 1C as an example. Note that a plain image or the like which is used for a background of the character string which is displayed so as to overlap with the first region 41 is erased at the same time as erasure of the character string.

The method for processing and displaying image information, which is one embodiment of the present invention and described in this embodiment, includes a step of specifying a character string which a user tries to distinguish and a step of enlarging and displaying the character string. Accordingly, without losing browsability of information, a character string with a size in accordance with accommodation ability of an eye of a user can be displayed on a display portion of an information processor. As a result, a novel method for processing and displaying image information can be provided.

### Modification Example

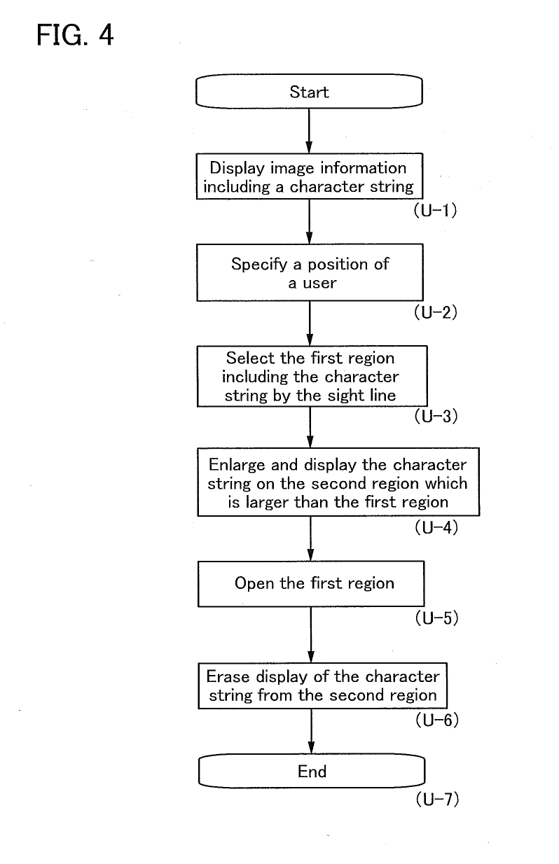

As a modification example of this embodiment, a method for processing and displaying image information in which the first region is opened by selection of a region other than the first region and the second region in the fourth step is described (see FIG. 3 (S-4b)).

In the case where coordinates different from the coordinates that have already been inputted by the user are inputted and the coordinates are in the first region and the second region, the first region is not opened.

For example, in the information processor 30B illustrated in FIG. 1B as an example, in the case where the user moves a finger along the first region in which a row including a character string pointed by the user is used as a unit, the arithmetic unit determines that the coordinates inputted from the touch panel are in the first region and does not open the first region.

In the case where the user moves a finger to point at another character string included in the next row of the row including a character string at which the user has pointed, the arithmetic unit determines that the coordinates inputted from the touch panel are outside the first region and opens the first region.

Note that at this time, the arithmetic unit may determine that a new first region including another character string is selected by the user and the character string included in the new first region may be newly displayed in a new second region. By this method, the user can select a new first region one after another by moving a finger in the row direction. Further, a character string included in a first region (e.g., a region which is selected in a row unit) that is selected one after another can be enlarged and displayed in a second region.

The method for processing and displaying image information, which is one embodiment of the present invention, includes a step of opening the first region including a portion which a user tries to distinguish by selecting of a region other than the first region and the second region. Accordingly, the frequency of occurrence of operation errors in that enlarged display is completed by mistake while the user identifies a character string included in the first region, for example, can be reduced. As a result, a novel method for processing and displaying image information, which is excellent in operability, can be provided.

This embodiment can be combined with any of the other embodiments in this specification as appropriate.

### Embodiment 2

In this embodiment, a novel method for processing and displaying image information, which is one embodiment of the present invention, is described with reference to FIG. 4.

FIG. 4 is a flow chart illustrating the method for processing and displaying image information, which is one embodiment of the present invention. FIG. 1A is a block diagram illustrating an information processor capable of employing the method for processing and displaying image information, which is one embodiment of the present invention, and FIG. 1C illustrates a method for using an information processor.

The method for processing and displaying image information, which is described as an example in this embodiment, includes the following steps.

### <First Step>

In a first step, image information including a character string is displayed on a display portion which includes a plurality of pixels with a resolution of 150 ppi or more and which is capable of eye-friendly display by using light which does not include light with a wavelength shorter than 420 nm (see FIG. 4 (U-1)).

### <Second Step>

In a second step, one user is specified in accordance with positions of users with respect to the display portion (see FIGS. 1A to 1C and FIG. 4 (U-2)).

In the case where the information processor is used simultaneously by a plurality of users, the information processor is operated by one user specified by the information processor. There are various methods in which the information processor specifies one user from the plurality of users. In this embodiment, the case where one user is specified by the distance sensor 24 is described.

The information processor 30C specifies one user in accordance with the positions of the users with respect to the display portion. For example, the distance sensor 24 may be positioned near the display portion and a person who is the closest to the distance sensor 24 may be specified as one user. In the case where the plurality of users are the same distance from the distance sensor 24, a person who is the closest to the central line of the display portion may be specified as one user.

For example, an optical distance sensor or an ultrasonic distance sensor can be used as the distance sensor 24. Further, the positions of the users can be specified with high accuracy by a plurality of distance sensors and triangulation.

Further, a user who tries to distinguish a character may move and display a region including a character string to be distinguished to the center of the display portion 22. Therefore, in the case where the information processor 30C detects a plurality of sight lines, the sight line that is the closest to the central line of the screen may be specified as that of one user.

### <Third Step>

In a third step, the first region including a character string is selected by the sight line of the user (see FIG. 4 (U-3)).

### <Fourth Step>

In a fourth step, the character string is enlarged and displayed in the second region which is larger than the first region (see FIG. 4 (U-4)).

### <Fifth Step>

In a fifth step, the first region is opened (see FIG. 4 (U-5)).

### <Sixth Step>

In a sixth step, display of the character string is erased from the second region and the flow is finished (see FIG. 4 (U-6) and FIG. 4 (U-7)).

The method for processing and displaying image information, which is one embodiment of the present invention, includes a step of specifying one user in accordance with positions of users with respect to a display portion, a step of specifying a character string which the user tries to distinguish, and a step of enlarging and displaying the character string. Accordingly, without losing browsability of information, a character string with a size in accordance with accommodation ability of an eye of a user can be displayed on a display portion of an information processor by one user specified from a plurality of users. As a result, a novel method for processing and displaying image information can be provided.

### Embodiment 3

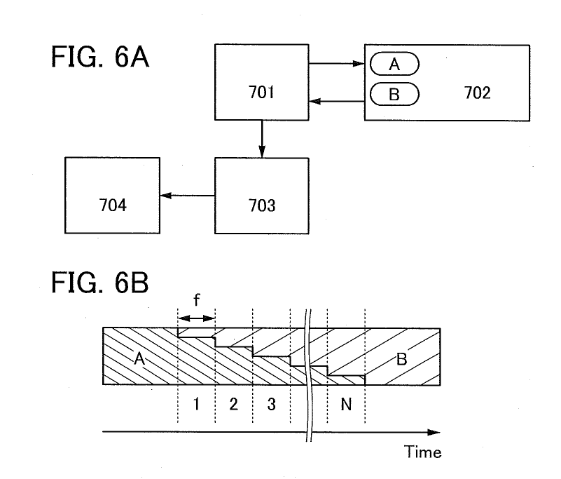

In this embodiment, an information processing method of an information processor of one embodiment of the present invention is described with reference to FIGS. 6A and 6B.

Specifically, description is given on a method for generating an image that can be displayed on the display portion of the information processor of one embodiment of the present invention. In particular, description is given on a method of switching images in an eye-friendly way when a character string is displayed or erased, a method of switching images with less eye fatigue given to a user, and a method of switching images without strain on the eyes of a user. In the method, an image displayed on the display portion described in Embodiment 1 or Embodiment 2 is provided in the second region.

FIG. 6A shows a block diagram illustrating the structure of the information processor. The method for processing and displaying image information, which is one embodiment of the present invention, can be applied to the information processor.

### <Information Processing Method>

In one embodiment of the present invention, in the third step of Embodiment 1 or the fourth step of Embodiment 2, an image including an enlarged character string is gradually displayed in the second region which is larger than the first region.

The above structure reduces the strain put on the user's eyes when display images are switched. It is thus possible to provide a novel information processing method which enables eye-friendly display of an image including information processed by an arithmetic unit.

A user may feel eye fatigue when images are rapidly switched and displayed, for example, when scenes are switched frequently in a moving image or when a still image is switched to a different still image.

Thus, when discontinuous images are switched in a displayed image, it is preferable to display images by switching the images gradually (gently) and naturally, not by switching displays momentarily.

For example, a technique such as fade-in or fade-out is preferably used when display is switched between a first image and a second image which are discontinuous images. In particular, the first image and the second image may be temporarily overlapped with each other so that the second still image fades in at the same time when the first image fades out (this technique is also referred to as crossfading). Alternatively, a state where the first image gradually changes into the second image (also referred to as morphing) may be displayed.

For example, in the case where two still image data are sequentially displayed, the first still image data is displayed at a low refresh rate, the first still image data is switched to the second still image data at a high refresh rate, and the second still image data is displayed at a low refresh rate again.

### <Fade-in, Fade-Out>

An example of a method for switching an image A and an image B which are discontinuous images is described below.

FIG. 6A shows a block diagram illustrating a structure of a display portion in which images can be switched. The display portion illustrated in FIG. 6A includes an arithmetic unit 701, a storage unit 702, a control unit 703, and a display unit 704.

In a first step, data of the image A and data of the image B input from an external memory device or the like are stored in the storage unit 702 by the arithmetic unit 701.

In a second step, the arithmetic unit 701 sequentially generates new image data based on the data of the image A and the data of the image B in accordance with a predetermined number by which the image data is divided.

In a third step, the generated image data is output to the control unit 703. The control unit 703 makes the input image data be displayed on the display unit 704.

FIG. 6B is a schematic diagram illustrating image data used when images are switched step-by step from the image A to the image B.

FIG. 6B shows a case where N image data (N is a natural number) are generated between the period that the image A is displayed and the period that the image B is displayed, and each image data is shown for f frame periods (f is a natural number). Thus, the period for the switching from the image A to the image B is f×N frame periods.

It is preferable that a user can freely set the parameters such as N and f. The arithmetic unit 701 obtains these parameters in advance and generates image data in accordance with the parameters.

The i-th image data (i is an integer of greater than or equal to 1 and smaller than or equal to N) can be generated by obtaining weighted average of the image data of the image A and the image data of the image B using successively varying coefficients. For example, in a pixel, when the luminance (gray level) in the case of displaying the image A is “a” and the luminance (gray level) in the case of displaying the image B is “b”, the luminance (gray level) “c” in the case of displaying the i-th image data is a value in Formula 1. Note that the gray level means a level of gradation displayed on the display portion. An image with gradation of only two levels, white and black, can be referred to as an image with two gray levels. For example, a display portion of a conventional personal computer includes subpixels which display red, green, and blue. Signals for expressing gradation of 256 levels are input to the subpixels.

$$\begin{matrix}[ Formula 1 ] & \\ c = \frac{( N + 1 - i ) a + i b}{N + 1} & ( 1 )\end{matrix}$$

The image A is switched to the image B using the image data generated by such a method, so that discontinuous images can be switched gradually (gently) and naturally.

Note that in Formula 1, in the case where “a”=0 in all pixels (the case where the image A is a black image), a black image is gradually switched to the image B (that is, fade-in). Further, in the case where “b”=0 in all pixels (the case where the image B is a black image), the image A is gradually switched to a black image (that is, fade-out).

The above describes a method for switching images by overlapping two images temporarily; however, a method in which two images are not overlapped may be employed.

In the case where two images are not overlapped with each other, a black image may be inserted while the image A is switched to the image B. In this case, the above image switching method can be used when the image A is switched to the black image and/or the black image is switched to the image B. The image inserted between the image A and the image B is not limited to a black image, and may be a single color image such as a white image or a multi-color image which is different from the image A and the image B.

When another image, in particular a single color image such as a black image, is inserted between the image A and the image B, a user can feel the timing of the switch of images more naturally; thus, images can be switched without giving the user stress.

This embodiment can be combined with any of the other embodiments in this specification as appropriate.

### Embodiment 4

In this embodiment, a program of one embodiment of the present invention is described with reference to FIGS. 1A to 1C and FIG. 2.

In this embodiment, described is a program that makes the information processor 30 execute the following treatment. The information processor 30 includes the arithmetic unit 11, the input unit 21, and the display portion 22 which includes a plurality of pixels for displaying information processed in the arithmetic unit 11 at a resolution of 150 ppi or more and which is capable of eye-friendly display by using light which does not include light with a wavelength shorter than 420 nm.

In the first step, image information including a character string is displayed on the display portion (see FIG. 2 (S-1)).

In the second step, the first region including the character string is selected (see FIG. 2 (S-2)).

In the third step, the character string is enlarged and displayed in the second region which is larger than the first region (see FIG. 2 (S-3)).

In the fourth step, the first region is opened (see FIG. 2 (S-4)).

In the fifth step, display of the character string is erased from the second region and the flow is finished (see FIGS. 2 (S-5) and (S-6)).

The program for processing and displaying image information, which is one embodiment of the present invention, includes a step of specifying a character string which a user tries to distinguish and a step of enlarging and displaying the character string. Accordingly, without losing browsability of information, a character string with a size in accordance with accommodation ability of an eye of a user can be displayed on a display portion of an information processor. As a result, a novel program for processing and displaying image information can be provided.

Further, a program of one embodiment of the present invention can be provided and received via an electric telecommunication line. For example, a server in which a program of one embodiment of the present invention is stored can provide the program via a network and distribute it in accordance with a request of an information processor. Further, the information processor in which the program of one embodiment of the present invention provided via a network is stored can be used.

This embodiment can be combined with any of the other embodiments in this specification as appropriate.

### Embodiment 5

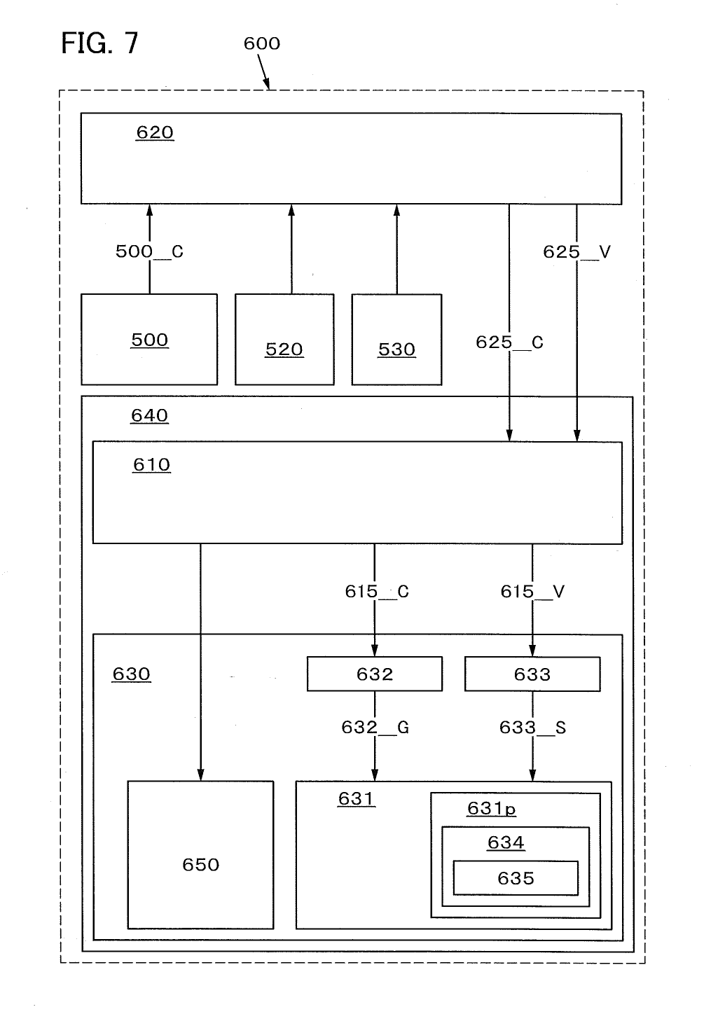

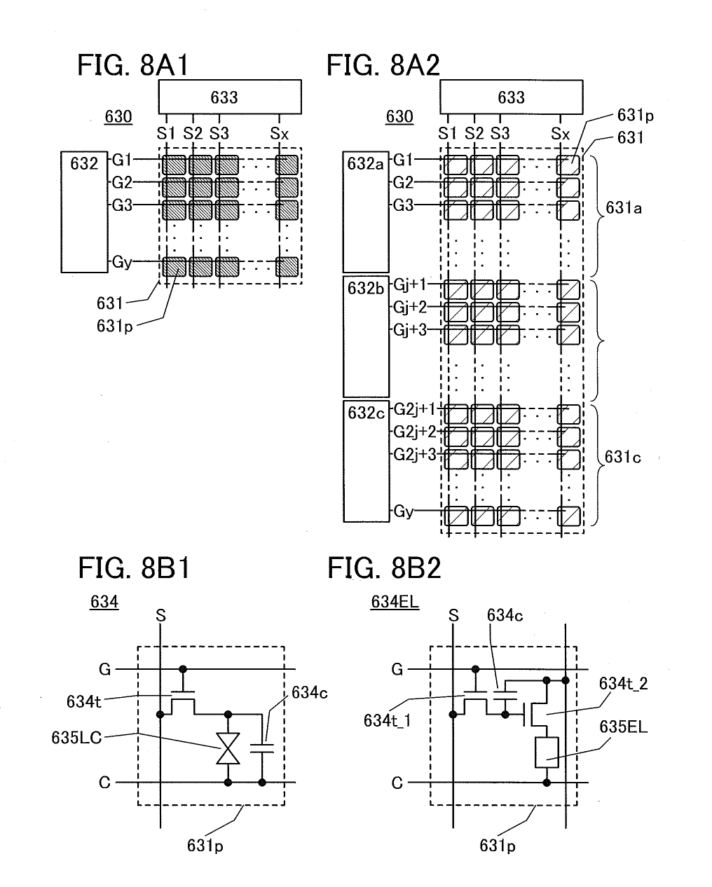

In this embodiment, a structure of an information processor which is capable of processing and displaying image information using a method of one embodiment of the present invention is described with reference to FIG. 7 and FIGS. 8A1, 8A2, 8B1, and 8B2.

Specifically, description is given on an information processor which has a first mode in which a G signal for selecting a pixel is output at a rate of 30 Hz (30 times per second) or more, preferably more than or equal to 60 Hz (60 times per second) and less than 960 Hz (960 times per second) and a second mode in which the G signal is output at a rate of more than or equal to 11.6 μHz (once per day) and less than 0.1 Hz (0.1 times per second), preferably more than or equal to 0.28 mHz (once per hour) and less than 1 Hz (once per second).

When a still image is displayed with the information processor of one embodiment of the present invention, the refresh rate can be set to less than 1 Hz, preferably less than or equal to 0.2 Hz. This enables eye-friendly display, i.e., display which causes less eye fatigue of a user or display which does not put strain on the user's eyes. Further, a display image can be refreshed at an optimal rate in accordance with the quality of the image displayed on the display portion. Specifically, in displaying a still image, the refresh rate can be set lower than that in displaying a smooth moving image; thus, a still image with less flicker can be displayed. In addition, this can reduce power consumption.

FIG. 7 is a block diagram of a structure of an information processor with a display function of one embodiment of the present invention.

FIGS. 8A1 and 8A2 show block diagrams each showing a structure of a display portion of a display device of one embodiment of the present invention.

An information processor 600 with a display function, which is described in this embodiment, includes a display device 640, an arithmetic device 620, and an input unit 500 (see FIG. 7).

In addition, a sight line detector 520 and a distance sensor 530 can be provided.

### <1. Structure of Display Device 640>

The display device 640 includes a display portion 630 and a control portion 610 (see FIG. 7). A primary image signal 625_V and a primary control signal 625_C can be supplied to the display device 640. The display device 640 can display image information on the display portion 630.

The primary image signal 625_V includes, for example, chromaticity information on an image as well as grayscale information (also can be referred to as luminance information).

The primary control signal 625_C includes a signal for controlling the timing for starting selection of a scanning line of the display device 640, for example.

Note that a power supply potential or the like is supplied to the control portion 610 and the display portion 630 in the display device 640.

### <<1.1 Control Portion 610>>

The control portion 610 has a function of controlling the display portion 630. For example, the control portion 610 generates a secondary image signal 615_V and/or a secondary control signal 615_C.

The control portion 610 may include, for example, a polarity determination circuit. The polarity determination circuit can invert the polarity of a signal every frame.

The polarity determination circuit notifies the timing at which the polarity of the secondary image signal 615_V is to be inverted; accordingly, the control portion 610 may be configured to invert the polarity of the secondary image signal 615_V at the notified timing. Note that the polarity of the secondary image signal 615_V may be inverted in the control portion 610, or may be inverted in the display portion 630 in accordance with an instruction from the control portion 610.

The polarity determination circuit may also include a counter and a signal generation circuit and have a function of determining the timing at which the polarity of the secondary image signal 615_V is inverted by using a synchronizing signal.

The counter has a function of counting the number of frame periods by using the pulse of a horizontal synchronizing signal. The signal generation circuit has a function of notifying the control portion 610 of the timing at which the polarity of the secondary image signal 615_V is inverted. This allows the polarity of the secondary image signal 615_V to be inverted every several successive frame periods with the use of information on the number of frame periods obtained by the counter.

### <<1.1.1 Secondary Image Signal>>

The secondary image signal 615_V can include image data.

For example, the control portion 610 may generate the secondary image signal 615_V from the primary image signal 625_V and output the secondary image signal 615_V.

The control portion 610 may also generate, as the secondary image signal 615_V, a signal whose amplitude is a difference between the potential of the primary image signal 625_V and a reference potential Vsc and whose polarity is inverted every frame.

### <<1.1.2 Secondary Control Signal>>

The secondary control signal 615_C can include a signal for controlling a first driver circuit (also referred to as a G driver circuit 632) of the display portion 630 or a signal for controlling a second driver circuit (also referred to as an S driver circuit 633) of the display portion 630.

For example, the control portion 610 may generate the secondary control signal 615_C from the primary control signal 625_C including a synchronizing signal such as a vertical synchronizing signal or a horizontal synchronizing signal.

The secondary control signal 615_C includes, for example, a start pulse signal SP, a latch signal LP, a pulse width control signal PWC, and a clock signal CK.

Specifically, the secondary control signal 615_C includes an S driver circuit start pulse signal SP, an S driver circuit clock signal CK, a latch signal LP, and the like that control the operation of the S driver circuit 633. The secondary control signal 615_C can also include a G driver circuit start pulse signal SP, a G driver circuit clock signal CK, a pulse width control signal PWC, and the like that control the operation of the G driver circuit 632.

### <<1.2 Structure of Display Portion 630>>

The display portion 630 includes a pixel portion 631, a first driver circuit (also referred to as the G driver circuit 632), and a second driver circuit (also referred to as the S driver circuit 633).

The pixel portion 631 does not include light with a wavelength shorter than 420 nm as display light and includes a plurality of pixels 631p arranged at a resolution of 150 ppi or more and wirings that connect the plurality of pixels 631p. Each of the plurality of pixels 631p is connected to at least one of scan lines G and at least one of signal lines S. Note that the kinds and number of the wirings depend on the structure, number, and position of the pixel 631p.

For example, in the case where the pixels 631p are arranged in a matrix of x columns and y rows in the pixel portion 631, the signal lines S1 to Sx and scan lines G1 to Gy are provided in the pixel portion 631 (see FIG. 8A1). The plurality of scan lines (G1 to Gy) can supply G signals to the respective rows. The plurality of signal lines (S1 to Sx) can supply S signals to the plurality of pixels.

The G driver circuit 632 can control the supply of a G signal 632_G and select the scan line G (see FIG. 7).

For example, the pixel portion 631 may be divided into a plurality of regions (specifically, a first region 631a, a second region 631b, and a third region 631c) to be driven (see FIG. 8A2).

In each region, the plurality of pixels 631p, the plurality of scan lines G for selecting the pixels 631p row by row, and the plurality of signal lines S for supplying S signals 633_S to the selected pixels 631p can be provided.

In addition, a plurality of G driver circuits (specifically, a first G driver circuit 632a, a second G driver circuit 632b, and a third G driver circuit 632c) may be provided.

The G driver circuit can control the supply of a G signal 632_G and select the scan lines G in each region (specifically, the scan lines G1 to Gj in the first G driver circuit 632a, the scan lines Gj+1 to G2j in the second G driver circuit 632b, and the scan line G2j+1 to Gy in the third G driver circuit 632c).

### <<1.2.1 G Driver Circuit>>

The G driver circuit outputs the first driving signal (G signal) 632_G for selecting the pixel circuit 634 to the pixel circuit 634. The G driver circuit 632 has a first mode of outputting the G signal 632_G for selecting a scan line to each scan line at a rate of 30 Hz (30 times per second) or more, preferably more than or equal to 60 Hz (60 times per second) and less than 960 Hz (960 times per second) and a second mode of outputting the G signal 632_G to each scan line at a rate of more than or equal to 11.6 μHz (once per day) and less than 0.1 Hz (0.1 times per second), preferably more than or equal to 0.28 mHz (once per hour) and less than 1 Hz (once per second).

The G driver circuit 632 can be switched between the first mode and the second mode to be operated. For example, the G driver circuit 632 can be switched between the first mode and the second mode with the use of the secondary control signal 615_C including a mode switching signal or the G driver circuit start pulse signal included in the secondary control signal 615_C. Specifically, the frequency of output of the G driver circuit start pulse signal from the control portion 610 may be controlled.

The G signal 632_G is generated by the G driver circuit 632. The G signals 632_G are output to the pixels 631p in each row, whereby the pixels 631p are selected row by row.

In the case where each of the pixel portions 631 divided into a plurality of regions has the G driver circuit, G driver circuits may be driven in different modes (see FIG. 8A2). For example, when an image in a state where browsability is kept is displayed in the first region driven in the first mode, flickers can be reduced. Further, when a user specifies a character string to be distinguished in the first region, the character string may be enlarged and displayed in the second region driven in the second mode. In this manner, a region where flickers tend to be caused can be reduced.

### <<1.2.2 S Driver Circuit>>

The display portion 630 may include the S driver circuit 633. The S driver circuit generates a second driver signal (also referred to as an S signal 633_S) from the secondary image signal 615_V and controls the supply of the S signals 633_S to the signal lines S (specifically S1 to Sx).

The S signal 633_S includes grayscale information on an image and the like. The S signal 633_S is supplied to the pixel 631p selected by the G signal 632_G

### <<1.2.3 Details of Structure of Pixel Portion 631>>

The pixel portion 631 includes the plurality of pixels 631p.

The pixel 631p includes a display element 635 and a pixel circuit 634 including the display element 635 (see FIG. 7).

The pixel circuit 634 holds the S signal 633_S supplied and displays some image data in the display element 635. The structure of the pixel circuit 634 can be selected in accordance with the kind or the driving method of the display element 635.

### <<1.2.3.1 Pixel Circuit>>

FIG. 8B 1 illustrates, as an example of the pixel circuit 634, a structure in which a liquid crystal element 635LC is used as the display element 635.

The pixel circuit 634 includes a transistor 634t including a gate electrode to which the G signal 632_G is input and a first electrode to which the S signal is input, and the liquid crystal element 635LC including a first electrode electrically connected to a second electrode of the transistor 634t and a second electrode to which a common potential is supplied.

The pixel circuit 634 includes the transistor 634t for controlling supply of the S signal 633_S to the display element 635.

A gate of the transistor 634t is connected to any one of the scan lines G1 to Gy. One of a source and a drain of the transistor 634t is connected to any one of the signal lines S1 to Sx. The other of the source and the drain of the transistor 634t is connected to the first electrode of the display element 635.

In the pixel 631p, one transistor 634t is used as a switching element for controlling input of the S signal 633_S to the pixel 631p. Alternatively, a plurality of transistors which serve as one switching element may be used in the pixel 631p. In that case, the plurality of transistors serving as one switching element may be connected to each other in parallel, in series, or in combination of parallel connection and series connection.

Note that the pixel 631p may include, in addition to the capacitor 634c for holding voltage between a first electrode and a second electrode of the liquid crystal element 635LC, another circuit element such as a transistor, a diode, a resistor, a capacitor, or an inductor as needed. A predetermined common potential Vcom is applied to the second electrode of the display element 635.

The capacitance of the capacitor 634c may be adjusted as appropriate. For example, in the second mode described later, the capacitor 634c is provided in the case where the S signals 633_S are held for a relatively long period (specifically, 1/60 sec or longer). The capacitance of the pixel circuit 634 may be adjusted using a component other than the capacitor 634c. For example, the first electrode and the second electrode of the liquid crystal element 635LC may be overlapped with each other to substantially form a capacitor.

FIG. 8B2 illustrates, as another example of the pixel circuit 634, a structure in which an EL element 635EL is applied to the display element 635.

A pixel circuit 634EL includes a first transistor 634t_1 including a gate electrode to which the G signal 632_G is input, a first electrode to which the S signal is input, and a second electrode which is electrically connected to a first electrode of the capacitor 634c. The pixel circuit 634EL also includes a second transistor 634t_2 including a gate electrode electrically connected to a second electrode of the first transistor 634t 1, a first electrode electrically connected to a second electrode of the capacitor 634c, and a second electrode electrically connected to a first electrode of the EL element 635EL. A power supply potential is supplied to the second electrode of the capacitor 634c and the first electrode of the second transistor 634t 2, and a common potential is supplied to a second electrode of the EL element 635EL. Note that the difference between the power supply potential and the common potential is higher than the emission start voltage of the EL element 635EL.

### <<1.2.3.2 Transistor>>

In the pixel circuit 634, the transistor 634t controls whether to apply the potential of the signal line S to the first electrode of the display element 635.

Note that a transistor including an oxide semiconductor can be suitably used as the transistor in the display device of one embodiment of the present invention. Embodiment 7 can be referred to for the details of the transistor including an oxide semiconductor.

A transistor including an oxide semiconductor film can have leakage current between a source and a drain in an off state (off-state current) much lower than that of a conventional transistor including silicon. When a transistor with extremely low off-state current is used in a pixel portion of a display portion, frame frequency can be lowered while flicker is reduced.

### <<1.2.3.3 Display Element>>

Besides the liquid crystal element 635LC, any of a variety of display elements such as an electroluminescence (EL) element as described with reference to FIG. 8B2 or electronic ink utilizing electrophoresis can be used as the display element 635.

Here, for example, the polarized light transmittance of the liquid crystal element 635LC can be controlled by the potential of the S signal 633_S; thus, gradation can be expressed.

### <<1.2.4 Light Supply Portion>>

For example, in the case where a transmissive liquid crystal element is used as the display element 635, a light supply portion 650 can be provided in the display portion 630. The light supply portion 650 includes a light source. The control portion 610 controls driving of the light source in the light supply portion 650. The light supply portion 650 supplies light to the pixel portion 631 including liquid crystal elements and functions as a backlight. In the case of using a self-luminous display element (e.g., OLED or LED) or a reflective display element (e.g., a reflective liquid crystal element or electronic ink), the light supply portion is not necessarily provided.

The light source in the light supply portion 650 can be a cold cathode fluorescent lamp, a light-emitting diode (LED), an OLED element, or the like.

In particular, the intensity of blue light emitted by the light source is preferably weakened compared to that of light of any other color. Since blue light included in light emitted from the light source is not absorbed by the cornea and lens of the eye and reaches the retina, this structure can reduce long-term effects of blue light on the retina (e.g., age-related macular degeneration), adverse effects of exposure to blue light until midnight on the circadian rhythm, and the like. Specifically, it is preferable to use a light source which does not emit light with a wavelength shorter than or equal to 400 nm, preferably shorter than or equal to 420 nm, more preferably shorter than or equal to 440 nm (such light is also referred to as UVA).

### <2. Arithmetic Unit>

The arithmetic device 620 generates the primary image signal 625_V and the primary control signal 625_C including a mode switching signal.

### <<Example 1 of Primary Control Signal Including Mode Switching Signal>>

The mode switching signal may be generated by, for example, order of a user of the information processor 600.

The user of the information processor 600 can give an order to switch display by using the input unit 500. The arithmetic device 620 may be configured to be supplied with an image switching signal 500_C and to output the primary control signal 625_C including the mode switching signal.

The primary control signal 625_C including a mode switching signal is supplied to the control portion 610 in the display device 640, and the primary control signal 625_C including the mode switching signal is output by the control portion.

For example, when the primary control signal 625_C including the mode switching signal for switching the G driver circuit 632 from the second mode to the first mode is supplied to the G driver circuit 632, the G driver circuit 632 is switched from the second mode to the first mode. After that, the G driver circuit 632 outputs the G signal for at least one frame, and then switched to the second mode.

Specifically, the input unit 500 may be configured to output the image switching signal 500_C to the arithmetic device 620 when sensing a page turning operation.

The arithmetic device 620 generates the primary image signal 625_V including the page turning operation and outputs the primary image signal 625_V as well as the primary control signal 625_C including a mode switching signal.

The control portion 610 supplied with the primary image signal 625_V and the primary control signal 625_C supplies the secondary control signal 615_C including the mode switching signal and the secondary image signal 615_V for executing the page turning operation.

The G driver circuit 632 supplied with the secondary control signal 615_C including the mode switching signal is switched from the second mode to the first mode and outputs the G signal 632_G at a high rate.

The S driver circuit 633 supplied with the secondary image signal 615_V including the page turning operation outputs the S signal 633_S generated from the secondary image signal 615_V to the pixel circuit 634.

In this manner, many frame images including the page turning operation can be rewritten at high rate by the pixels 631p. As a result, smooth images based on the secondary image signals 615_V for executing the page turning operation can be displayed.

### <<Example 2 of Primary Control Signal Including Mode Switching Signal>>

The arithmetic device 620 may be configured to determine whether an image based on the primary image signal 625_V output to the display portion 630 is a moving image or a still image and to output the primary control signal 625_C including the mode switching signal in accordance with the determination result.

Specifically, the arithmetic device 620 outputs a switching signal for selecting the first mode when the image based on the primary image signal 625_V is a moving image and outputs a switching signal for selecting the second mode when the image based on the primary image signal 625_V is a still image.

A method for determining whether the image based on the primary image signal is a moving image or a still image is as follows. Signals for one frame included in the primary image signal 625_V are compared with signals for the previous frame and the next frame. It is determined that the image is a moving image when the difference between the signals is greater than a predetermined difference, and it is determined that the image is a still image in other cases.

When the control portion 610 switches the operating mode of the G driver circuit from one mode to another mode (e.g., from the second mode to the first mode), the G driver circuit may be configured to output the G signals 632_G one or more predetermined times, and then be switched to the other mode.

### <3. Input Unit>

As the input unit 500, a touch panel, a touch pad, a mouse, a finger joystick, a trackball, a data glove, or an imaging device can be used, for example. In the arithmetic device 620, an electric signal output from the input unit 500 can be associated with coordinates of a display portion. Accordingly, a user can input an instruction for processing information displayed on the display portion.

Examples of information input with the input unit 500 by a user are instructions for dragging an image displayed on the display portion to another position on the display portion; for swiping a screen for turning a displayed image and displaying the next image; for scrolling a continuous image; for selecting a specific image; for pinching a screen for changing the size of a displayed image; and for inputting handwritten characters.

This embodiment can be combined with any of the other embodiments in this specification as appropriate.

### <4. Sensor>

The sight line detector 520 detects a sight line of a user who watches the display portion 630 of the information processor 600. As a method for detecting a sight line of a user, a method can be given, for example, in which a face of the user is taken with a camera or the like and the sight line is estimated in accordance with the position of the user's eyeball.

The distance sensor 530 detects the distance to the position of a user who watches the display portion 630 of the information processor 600.

For example, in the case where the information processor 600 is used simultaneously by a plurality of users, the information processor 600 can specify a user who is the closest to the display portion 630 and can detect the sight line of the user.

Further, the information processor 600 may determine a size of a character to be enlarged and displayed in the second region which is larger than the first region of the display portion in accordance with the distance to the position of a user. Specifically, as the distance to the position of the user becomes longer, a character may be displayed larger.

### Embodiment 6

Examples of a semiconductor and a semiconductor film which are preferably used for a region where a channel is formed in a transistor are described below.

An oxide semiconductor has a wide energy gap of 3.0 eV or more. A transistor including an oxide semiconductor film obtained by processing of the oxide semiconductor in an appropriate condition and a sufficient reduction in carrier density of the oxide semiconductor can have much lower leakage current between a source and a drain in an off state (off-state current) than a conventional transistor including silicon.

A transistor which includes the semiconductor film described in this embodiment and has low off-state current can be used in the display portion of the information processor described in Embodiment 5. Specifically, when the transistor is used as a switching element in the pixel circuit included in the pixel portion, a display state of a display element can be held for a long time as compared with a conventional transistor (e.g., a transistor in which amorphous silicon is used for a semiconductor film). Thus, the rate of output of G signals for selecting pixels in the display portion of the information processor can be significantly reduced as described in Embodiment 5.

In the case where an oxide semiconductor film is used for a transistor, the thickness of the oxide semiconductor film is preferably greater than or equal to 1 nm and less than or equal to 100 nm, further preferably greater than or equal to 2 nm and less than or equal to 40 nm.

An applicable oxide semiconductor preferably contains at least indium (In) or zinc (Zn). In particular, In and Zn are preferably contained. In addition, as a stabilizer for reducing variation in electrical characteristics of a transistor using the oxide semiconductor, one or more elements selected from gallium (Ga), tin (Sn), hafnium (Hf), zirconium (Zr), titanium (Ti), scandium (Sc), yttrium (Y), and a lanthanoid (such as cerium (Ce), neodymium (Nd), or gadolinium (Gd)) is preferably contained.

As the oxide semiconductor, for example, any of the following can be used: indium oxide, tin oxide, zinc oxide, an In—Zn-based oxide, a Sn—Zn-based oxide, an Al—Zn-based oxide, a Zn—Mg-based oxide, a Sn—Mg-based oxide, an In—Mg-based oxide, an In—Ga-based oxide, an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—Zr—Zn-based oxide, an In—Ti—Zn-based oxide, an In—Sc—Zn-based oxide, an In—Y—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide.

Here, an “In—Ga—Zn-based oxide” means an oxide containing In, Ga, and Zn as its main components and there is no particular limitation on the ratio of In, Ga, and Zn. The In—Ga—Z-based oxide may contain another metal element in addition to In, Ga, and Zn.

Alternatively, a material represented by InMO₃(ZnO)ₘ (m>0 is satisfied, and m is not an integer) may be used as an oxide semiconductor. Note that M represents one or more metal elements selected from Ga, Fe, Mn, and Co, or the above-described element as a stabilizer. Alternatively, as the oxide semiconductor, a material represented by a chemical formula, In₂SnO₅(ZnO)ₙ (n>0, n is a natural number) may be used.

For example, In—Ga—Zn-based oxide with an atomic ratio where In:Ga:Zn=1:1:1, In:Ga:Zn=1:3:2, In:Ga:Zn=3:1:2, or In:Ga:Zn=2:1:3, or an oxide whose composition is in the neighborhood of the above compositions can be used.

When the oxide semiconductor film contains a large amount of hydrogen, the hydrogen and an oxide semiconductor are bonded to each other, so that part of the hydrogen serves as a donor and causes generation of an electron which is a carrier. As a result, the threshold voltage of the transistor shifts in the negative direction. Therefore, it is preferable that, after formation of the oxide semiconductor film, dehydration treatment (dehydrogenation treatment) be performed to remove hydrogen or moisture from the oxide semiconductor film so that the oxide semiconductor film is highly purified to contain impurities as little as possible.

Note that oxygen in the oxide semiconductor film is also reduced by the dehydration treatment (dehydrogenation treatment) in some cases. Accordingly, it is preferable that oxygen be added to the oxide semiconductor film to fill oxygen vacancies increased by the dehydration treatment (dehydrogenation treatment). In this specification and the like, supplying oxygen to an oxide semiconductor film may be expressed as oxygen adding treatment, or treatment for making the oxygen content of an oxide semiconductor film be in excess of that of the stoichiometric composition may be expressed as treatment for making an oxygen-excess state.

In this manner, hydrogen or moisture is removed from the oxide semiconductor film by the dehydration treatment (dehydrogenation treatment) and oxygen vacancies therein are filled by the oxygen adding treatment, whereby the oxide semiconductor film can be turned into an i-type (intrinsic) oxide semiconductor film or a substantially i-type (intrinsic) oxide semiconductor film which is extremely close to an i-type oxide semiconductor film. Note that “substantially intrinsic” means that the oxide semiconductor film contains extremely few (close to zero) carriers derived from a donor and has a carrier density of lower than or equal to 1×10¹⁷/cm³, lower than or equal to 1×10¹⁶/cm³, lower than or equal to 1×10¹⁵/cm³, lower than or equal to 1×10¹⁴/cm³, or lower than or equal to 1×10¹³/cm³.

Thus, the transistor including an i-type or substantially i-type oxide semiconductor film can have extremely favorable off-state current characteristics. For example, the drain current at the time when the transistor including an oxide semiconductor film is in an off-state can be less than or equal to 1×10⁻¹⁸ A, preferably less than or equal to 1×10⁻²¹ A, further preferably less than or equal to 1×10⁻²⁴ A at room temperature (about 25° C.); or less than or equal to 1×10⁻¹⁵ A, preferably less than or equal to 1×10⁻¹⁸ A, further preferably less than or equal to 1×10⁻²¹ A at 85° C. Note that an off state of an n-channel transistor refers to a state where the gate voltage is sufficiently lower than the threshold voltage. Specifically, the transistor is in an off state when the gate voltage is lower than the threshold voltage by 1V or more, 2V or more, or 3V or more.

This embodiment can be combined with any of the other embodiments in this specification as appropriate.

### Embodiment 7

In this embodiment, structural examples of a transistor to which the oxide semiconductor film described in Embodiment 6 is applied are described with reference to drawings.

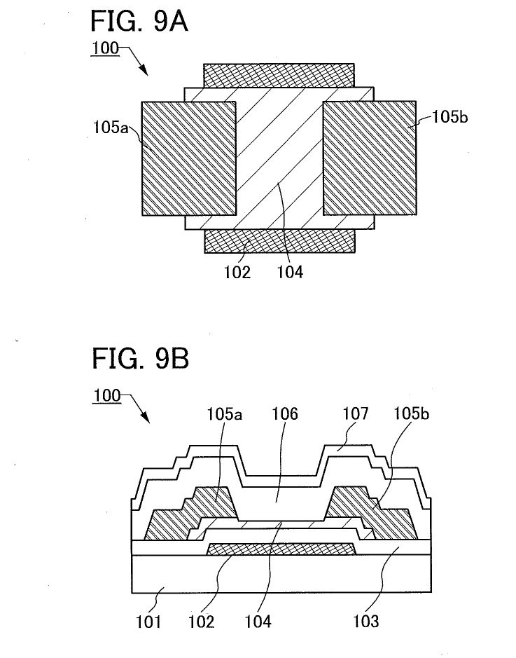

FIGS. 9A and 9B illustrate a structural example of a transistor of this embodiment.

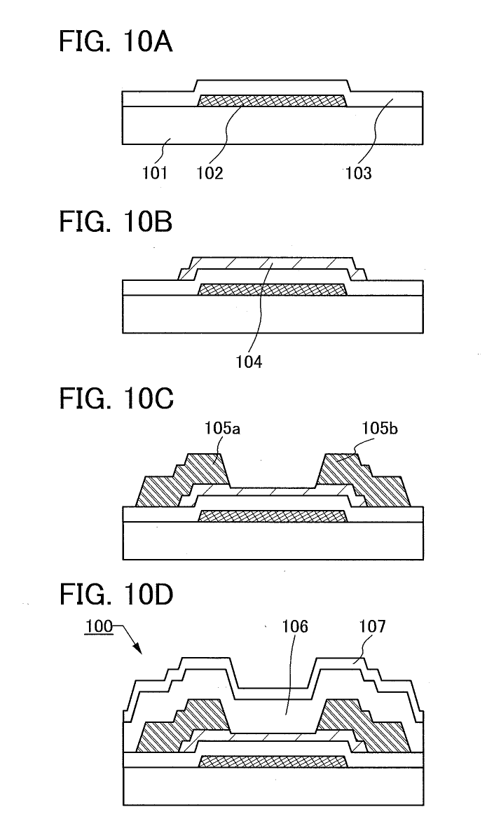

FIGS. 10A to 10D illustrate an example of a method for manufacturing a transistor of this embodiment.

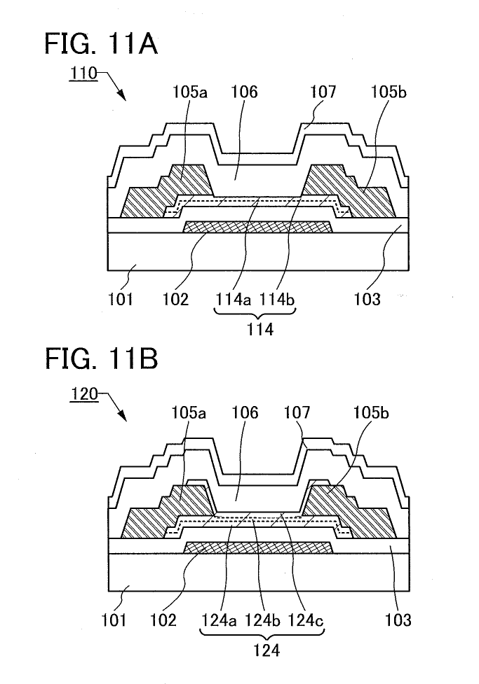

FIGS. 11A and 11B each illustrate a structural example of a transistor of this embodiment.

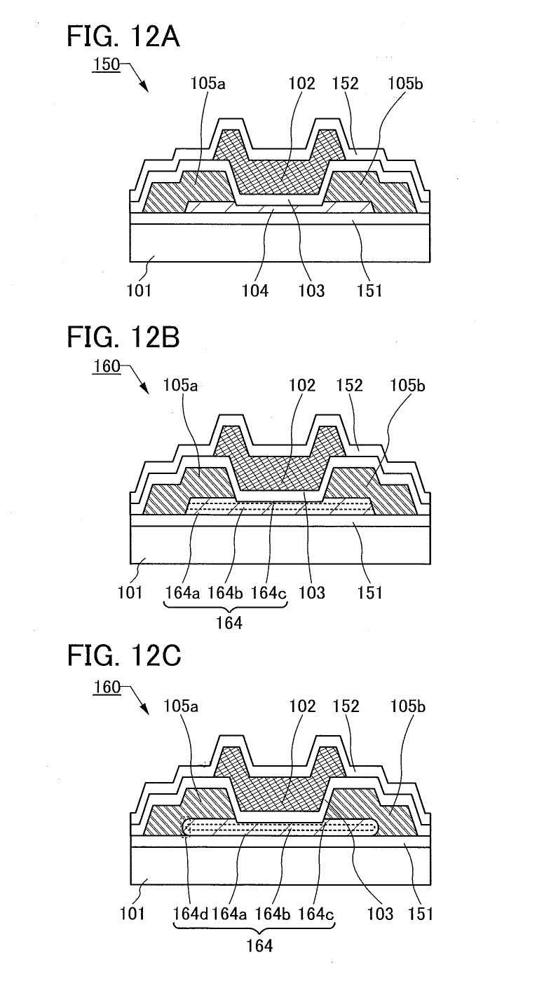

FIGS. 12A to 12C each illustrate a structural example of a transistor of this embodiment.

### <Structural Example of Transistor>

FIG. 9A is a schematic top view of a transistor 100 described below as an example. FIG. 9B is a schematic cross-sectional view of the transistor 100 illustrated in FIG. 9A. The transistor 100 described as an example in this structural example is a bottom-gate transistor.

The transistor 100 includes a gate electrode 102 provided over a substrate 101, an insulating layer 103 provided over the substrate 101 and the gate electrode 102, an oxide semiconductor layer 104 provided over the insulating layer 103 to overlap with the gate electrode 102, and a pair of electrodes 105a and 105b in contact with the top surface of the oxide semiconductor layer 104. Further, an insulating layer 106 is provided to cover the insulating layer 103, the oxide semiconductor layer 104, and the pair of electrodes 105a and 105b, and an insulating layer 107 is provided over the insulating layer 106.

The oxide semiconductor film described in Embodiment 6 can be applied to the oxide semiconductor layer 104 in the transistor 100.

### <<Substrate 101>>

There is no particular limitation on the property of a material and the like of the substrate 101 as long as the material has heat resistance enough to withstand at least heat treatment which will be performed later. For example, a glass substrate, a ceramic substrate, a quartz substrate, a sapphire substrate, or an yttria-stabilized zirconia (YSZ) substrate may be used as the substrate 101. Alternatively, a single crystal semiconductor substrate or a polycrystalline semiconductor substrate made of silicon, silicon carbide, or the like, a compound semiconductor substrate made of silicon germanium or the like, an SOI substrate, or the like can be used as the substrate 101. Still alternatively, any of these substrates provided with a semiconductor element may be used as the substrate 101.

Still alternatively, a flexible substrate such as a plastic substrate may be used as the substrate 101, and the transistor 100 may be provided directly on the flexible substrate. Further alternatively, a separation layer may be provided between the substrate 101 and the transistor 100. The separation layer can be used when part or the whole of the transistor formed over the separation layer is formed and separated from the substrate 101 and transferred to another substrate. Thus, the transistor 100 can be transferred to a substrate having low heat resistance or a flexible substrate.

### <<Gate Electrode 102>>

The gate electrode 102 can be formed using a metal selected from aluminum, chromium, copper, tantalum, titanium, molybdenum, and tungsten; an alloy containing any of these metals as a component; an alloy containing any of these metals in combination; or the like. Further, one or more metals selected from manganese and zirconium may be used. Furthermore, the gate electrode 102 may have a single-layer structure or a stacked-layer structure of two or more layers. For example, a single-layer structure of an aluminum film containing silicon, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, and the like can be given. Alternatively, an alloy film containing aluminum and one or more metals selected from titanium, tantalum, tungsten, molybdenum, chromium, neodymium, and scandium; or a nitride film of the alloy film may be used.

The gate electrode 102 can also be formed using a light-transmitting conductive material such as indium tin oxide, indium oxide containing tungsten oxide, indium zinc oxide containing tungsten oxide, indium oxide containing titanium oxide, indium tin oxide containing titanium oxide, indium zinc oxide, or indium tin oxide to which silicon oxide is added. It is also possible to have a stacked-layer structure formed using the above light-transmitting conductive material and the above metal.

Further, an In—Ga—Zn-based oxynitride semiconductor film, an In—Sn-based oxynitride semiconductor film, an In—Ga-based oxynitride semiconductor film, an In—Zn-based oxynitride semiconductor film, a Sn-based oxynitride semiconductor film, an In-based oxynitride semiconductor film, a film of metal nitride (such as InN or ZnN), or the like may be provided between the gate electrode 102 and the insulating layer 103. These films each have a work function of 5 eV or higher, preferably 5.5 eV or higher, which is higher than the electron affinity of an oxide semiconductor; thus, the threshold voltage of a transistor including the oxide semiconductor can be shifted in the positive direction. Accordingly, a switching element having what is called normally-off characteristics is obtained. For example, in the case of using an In—Ga—Zn-based oxynitride semiconductor film, an In—Ga—Zn-based oxynitride semiconductor film having a higher nitrogen concentration than at least the oxide semiconductor layer 104, specifically, an In—Ga—Zn-based oxynitride semiconductor film having a nitrogen concentration of 7 at.% or higher is used.

### <<Insulating Layer 103>>

The insulating layer 103 functions as a gate insulating film. The insulating layer 103 in contact with the bottom surface of the oxide semiconductor layer 104 is preferably an amorphous film.

The insulating layer 103 may be formed to have a single-layer structure or a stacked-layer structure using, for example, one or more of silicon oxide, silicon oxynitride, silicon nitride oxide, silicon nitride, aluminum oxide, hafnium oxide, gallium oxide, Ga—Zn-based metal oxide, silicon nitride, and the like.

The insulating layer 103 may be formed using a high-k material such as hafnium silicate (HfSiOₓ), hafnium silicate to which nitrogen is added (HfSiₓO_{y}N_{z}), hafnium aluminate to which nitrogen is added (HfAlₓO_{y}N_{z}), hafnium oxide, or yttrium oxide, so that gate leakage current of the transistor can be reduced.

<<Pair of Electrodes 105a and 105b>>

The pair of electrodes 105a and 105b functions as a source electrode and a drain electrode of the transistor.

The pair of electrodes 105a and 105b can be formed to have a single-layer structure or a stacked-layer structure using, as a conductive material, any of metals such as aluminum, titanium, chromium, nickel, copper, yttrium, zirconium, molybdenum, silver, tantalum, and tungsten, or an alloy containing any of these metals as its main component. For example, a single-layer structure of an aluminum film containing silicon, a two-layer structure in which a titanium film is stacked over an aluminum film, a two-layer structure in which a titanium film is stacked over a tungsten film, a two-layer structure in which a copper film is stacked over a copper-magnesium-aluminum alloy film, a three-layer structure in which a titanium film or a titanium nitride film, an aluminum film or a copper film, and a titanium film or a titanium nitride film are stacked in this order, a three-layer structure in which a molybdenum film or a molybdenum nitride film, an aluminum film or a copper film, and a molybdenum film or a molybdenum nitride film are stacked in this order, and the like can be given. Note that a transparent conductive material containing indium oxide, tin oxide, or zinc oxide may be used.

### <<Insulating Layers 106 and 107>>

The insulating layer 106 is preferably formed using an oxide insulating film containing oxygen at a higher proportion than oxygen in the stoichiometric composition. Part of oxygen is released by heating from the oxide insulating film containing oxygen at a higher proportion than oxygen in the stoichiometric composition. The oxide insulating film containing oxygen at a higher proportion than oxygen in the stoichiometric composition is an oxide insulating film in which the amount of released oxygen converted into oxygen atoms is greater than or equal to 1.0×10¹⁸ atoms/cm³, preferably greater than or equal to 3.0×10²⁰ atoms/cm³ in thermal desorption spectroscopy (TDS) analysis.

As the insulating layer 106, a silicon oxide film, a silicon oxynitride film, or the like can be formed.

Note that the insulating layer 106 also functions as a film which relieves damage to the oxide semiconductor layer 104 at the time of forming the insulating layer 107 later.

An oxide film transmitting oxygen may be provided between the insulating layer 106 and the oxide semiconductor layer 104.

As the oxide film transmitting oxygen, a silicon oxide film, a silicon oxynitride film, or the like can be formed. Note that in this specification, “silicon oxynitride film” refers to a film that contains more oxygen than nitrogen, and “silicon nitride oxide film” refers to a film that contains more nitrogen than oxygen.

The insulating layer 107 can be formed using an insulating film having a blocking effect against oxygen, hydrogen, water, and the like. It is possible to prevent outward diffusion of oxygen from the oxide semiconductor layer 104 and entry of hydrogen, water, or the like into the oxide semiconductor layer 104 from the outside by providing the insulating layer 107 over the insulating layer 106. As for the insulating film having a blocking effect against oxygen, hydrogen, water, and the like, a silicon nitride film, a silicon nitride oxide film, an aluminum oxide film, an aluminum oxynitride film, a gallium oxide film, a gallium oxynitride film, an yttrium oxide film, an yttrium oxynitride film, a hafnium oxide film, and a hafnium oxynitride film can be given as examples.

### <Example of Manufacturing Method of Transistor>

Next, an example of a manufacturing method of the transistor 100 illustrated in FIGS. 9A and 9B is described.

First, as illustrated in FIG. 10A, the gate electrode 102 is formed over the substrate 101, and the insulating layer 103 is formed over the gate electrode 102.

Here, a glass substrate is used as the substrate 101.

### <<Formation of Gate Electrode>>

A formation method of the gate electrode 102 is described below. First, a conductive film is formed by a sputtering method, a CVD method, an evaporation method, or the like and then a resist mask is formed over the conductive film using a first photomask by a photolithography process. Then, part of the conductive film is etched using the resist mask to form the gate electrode 102. After that, the resist mask is removed.

Note that instead of the above formation method, the gate electrode 102 may be formed by an electrolytic plating method, a printing method, an ink-jet method, or the like.

### <<Formation of Gate Insulating Layer>>

The insulating layer 103 is formed by a sputtering method, a CVD method, an evaporation method, or the like.

In the case where the insulating layer 103 is formed using a silicon oxide film, a silicon oxynitride film, or a silicon nitride oxide film, a deposition gas containing silicon and an oxidizing gas are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples.

In the case of forming a silicon nitride film as the insulating layer 103, it is preferable to use a two-step formation method. First, a first silicon nitride film with a small number of defects is formed by a plasma CVD method in which a mixed gas of silane, nitrogen, and ammonia is used as a source gas. Then, a second silicon nitride film in which the hydrogen concentration is low and hydrogen can be blocked is formed by switching the source gas to a mixed gas of silane and nitrogen. With such a formation method, a silicon nitride film with a small number of defects and a blocking property against hydrogen can be formed as the insulating layer 103.

Moreover, in the case of forming a gallium oxide film as the insulating layer 103, a metal organic chemical vapor deposition (MOCVD) method can be employed.

### <<Formation of Oxide Semiconductor Layer>>

Next, as illustrated in FIG. 10B, the oxide semiconductor layer 104 is formed over the insulating layer 103.

A formation method of the oxide semiconductor layer 104 is described below. First, an oxide semiconductor film is formed using the method described in Embodiment 6. Then, a resist mask is formed over the oxide semiconductor film using a second photomask by a photolithography process. Then, part of the oxide semiconductor film is etched using the resist mask to form the oxide semiconductor layer 104. After that, the resist mask is removed.

After that, heat treatment may be performed. In such a case, the heat treatment is preferably performed under an atmosphere containing oxygen.

### <<Formation of Pair of Electrodes>>

Next, as illustrated in FIG. 10C, the pair of electrodes 105a and 105b is formed.

A formation method of the pair of electrodes 105a and 105b is described below. First, a conductive film is formed by a sputtering method, a CVD method, an evaporation method, or the like. Then, a resist mask is formed over the conductive film using a third photomask by a photolithography process. Then, part of the conductive film is etched using the resist mask to form the pair of electrodes 105a and 105b. After that, the resist mask is removed.

Note that as illustrated in FIG. 10B, an upper part of the oxide semiconductor layer 104 is in some cases partly etched and thinned by the etching of the conductive film. For this reason, the oxide semiconductor layer 104 is preferably formed thick.

### <<Formation of Insulating Layer>>

Next, as illustrated in FIG. 10D, the insulating layer 106 is formed over the oxide semiconductor layer 104 and the pair of electrodes 105a and 105b, and the insulating layer 107 is successively formed over the insulating layer 106.

In the case where the insulating layer 106 is formed using a silicon oxide film or a silicon oxynitride film, a deposition gas containing silicon and an oxidizing gas are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples.

For example, a silicon oxide film or a silicon oxynitride film is formed under the conditions as follows: the substrate placed in a vacuum-evacuated treatment chamber of a plasma CVD apparatus is held at a temperature higher than or equal to 180° C. and lower than or equal to 260° C., preferably higher than or equal to 200° C. and lower than or equal to 240° C., to the treatment chamber is charged a source gas at a pressure greater than or equal to 100 Pa and less than or equal to 250 Pa, preferably greater than or equal to 100 Pa and less than or equal to 200 Pa, and high-frequency power higher than or equal to 0.17 W/cm² and lower than or equal to 0.5 W/cm², preferably higher than or equal to 0.25 W/cm² and lower than or equal to 0.35 W/cm² is supplied to an electrode provided in the treatment chamber.

As the film formation conditions, the high-frequency power having the above power density is supplied to the treatment chamber having the above pressure, whereby the decomposition efficiency of the source gas in plasma is increased, oxygen radicals are increased, and oxidation of the source gas is promoted; therefore, oxygen is contained in the oxide insulating film at a higher proportion than oxygen in the stoichiometric composition. However, in the case where the substrate temperature is within the above temperature range, the bond between silicon and oxygen is weak, and accordingly, part of oxygen is released by heating. Thus, it is possible to form an oxide insulating film which contains oxygen at a higher proportion than the stoichiometric composition and from which part of oxygen is released by heating.

Further, in the case of providing an oxide insulating film between the oxide semiconductor layer 104 and the insulating layer 106, the oxide insulating film serves as a protective film of the oxide semiconductor layer 104 in the steps of forming the insulating layer 106. Thus, the insulating layer 106 can be formed using the high-frequency power having a high power density while damage to the oxide semiconductor layer 104 is reduced.

For example, a silicon oxide film or a silicon oxynitride film can be formed as the oxide insulating film under the conditions as follows: the substrate placed in a vacuum-evacuated treatment chamber of a plasma CVD apparatus is held at a temperature higher than or equal to 180° C. and lower than or equal to 400° C., preferably higher than or equal to 200° C. and lower than or equal to 370° C., to the treatment chamber is charged a source gas at a pressure greater than or equal to 20 Pa and less than or equal to 250 Pa, preferably greater than or equal to 100 Pa and less than or equal to 250 Pa, and high-frequency power is supplied to an electrode provided in the treatment chamber. Further, when the pressure in the treatment chamber is greater than or equal to 100 Pa and less than or equal to 250 Pa, damage to the oxide semiconductor layer 104 can be reduced.

A deposition gas containing silicon and an oxidizing gas are preferably used as a source gas of the oxide insulating film. Typical examples of the deposition gas containing silicon include silane, disilane, trisilane, and silane fluoride. As the oxidizing gas, oxygen, ozone, dinitrogen monoxide, and nitrogen dioxide can be given as examples.

The insulating layer 107 can be formed by a sputtering method, a CVD method, or the like.

In the case where the insulating layer 107 is formed using a silicon nitride film or a silicon nitride oxide film, a deposition gas containing silicon, an oxidizing gas, and a gas containing nitrogen are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples. As the gas containing nitrogen, nitrogen and ammonia can be given as examples.

Through the above process, the transistor 100 can be formed.

### <Modification Example of Transistor 100>

Structural examples of transistors which are partly different from the transistor 100 are described below.

### Modification Example 1

FIG. 11A is a schematic cross-sectional view of a transistor 110 described as an example below. The transistor 110 is different from the transistor 100 in the structure of an oxide semiconductor layer.

In an oxide semiconductor layer 114 included in the transistor 110, an oxide semiconductor layer 114a and an oxide semiconductor layer 114b are stacked.

Since a boundary between the oxide semiconductor layer 114a and the oxide semiconductor layer 114b is unclear in some cases, the boundary is shown by a dashed line in FIG. 11A and the like.

The oxide semiconductor film of one embodiment of the present invention can be applied to one or both of the oxide semiconductor layers 114a and 114b.

Typical examples of a material that can be used for the oxide semiconductor layer 114a are an In—Ga oxide, an In—Zn oxide, and an In-M-Zn oxide (M is Al, Ti, Ga, Y, Zr, La, Ce, Nd, or Hf). When an In-M-Zn oxide is used for the oxide semiconductor layer 114a, the atomic ratio between In and M is preferably as follows: the atomic percentage of In is less than 50 at.% and the atomic percentage of M is greater than or equal to 50 at.%; further preferably, the atomic percentage of In is less than 25 at.% and the atomic percentage of M is greater than or equal to 75 at.%. Further, a material having an energy gap of 2 eV or more, preferably 2.5 eV or more, further preferably 3 eV or more is used for the oxide semiconductor layer 114a, for example.

For example, the oxide semiconductor layer 114b contains In or Ga; the oxide semiconductor layer 114b contains, for example, a material typified by an In—Ga oxide, an In—Zn oxide, or an In-M-Zn oxide (M is Al, Ti, Ga, Y, Zr, La, Ce, Nd, or Hf). In addition, the energy of the conduction band minimum of the oxide semiconductor layer 114b is closer to the vacuum level than that of the oxide semiconductor layer 114a is. The difference between the energy of the conduction band minimum of the oxide semiconductor layer 114b and the energy of the conduction band minimum of the oxide semiconductor layer 114a is preferably 0.05 eV or more, 0.07 eV or more, 0.1 eV or more, or 0.15 eV or more and 2 eV or less, 1 eV or less, 0.5 eV or less, or 0.4 eV or less.

When an In-M-Zn oxide is used for the oxide semiconductor layer 114b, for example, the atomic ratio between In and M is preferably as follows: the atomic percentage of In is greater than or equal to 25 at.% and the atomic percentage of M is less than 75 at.%; further preferably, the atomic percentage of In is greater than or equal to 34 at.% and the atomic percentage of M is less than 66 at.%.

For the oxide semiconductor layer 114a, an In—Ga—Zn oxide containing In, Ga, and Zn at an atomic ratio of 1:1:1 or 3:1:2 can be used, for example. Further, for the oxide semiconductor layer 114b, an In—Ga—Zn oxide containing In, Ga, and Zn at an atomic ratio of 1:3:2, 1:6:4, or 1:9:6 can be used. Note that the atomic ratio of each of the oxide semiconductor layers 114a and 114b varies within a range of ±20% of the above atomic ratio as an error.

When an oxide containing a large amount of Ga that serves as a stabilizer is used for the oxide semiconductor layer 114b provided over the oxide semiconductor layer 114a, oxygen can be prevented from being released from the oxide semiconductor layers 114a and 114b.

Note that, without limitation to that described above, a material with an appropriate composition may be used depending on required semiconductor characteristics and electrical characteristics (e.g., field-effect mobility and threshold voltage) of a transistor. Further, in order to obtain required semiconductor characteristics of a transistor, it is preferable that the carrier density, the impurity concentration, the defect density, the atomic ratio of a metal element to oxygen, the interatomic distance, the density, and the like of the oxide semiconductor layers 114a and 114b be set to be appropriate.

Although a structure in which two oxide semiconductor layers are stacked is described above as an example of the oxide semiconductor layer 114, a structure in which three or more oxide semiconductor layers are stacked can also be employed.

### Modification Example 2

FIG. 11B is a schematic cross-sectional view of a transistor 120 described as an example below. The transistor 120 is different from the transistor 100 and the transistor 110 in the structure of an oxide semiconductor layer.

In an oxide semiconductor layer 124 included in the transistor 120, an oxide semiconductor layer 124a, an oxide semiconductor layer 124b, and an oxide semiconductor layer 124c are stacked in this order.

The oxide semiconductor layers 124a and 124b are stacked over the insulating layer 103. The oxide semiconductor layer 124c is provided in contact with the top surface of the oxide semiconductor layer 124b and the top surfaces and side surfaces of the pair of electrodes 105a and 105b.

The oxide semiconductor film described in Embodiment 6 can be applied to one or more of the oxide semiconductor layers 124a, 124b, and 124c.

The oxide semiconductor layer 124b can have a structure which is similar to that of the oxide semiconductor layer 114a described as an example in Modification Example 1, for example. Further, the oxide semiconductor layers 124a and 124c can each have a structure which is similar to that of the oxide semiconductor layer 114b described as an example in Modification Example 1, for example.

When an oxide containing a large amount of Ga that serves as a stabilizer is used for the oxide semiconductor layer 124a, which is provided under the oxide semiconductor layer 124b, and the oxide semiconductor layer 124c, which is provided over the oxide semiconductor layer 124b, for example, oxygen can be prevented from being released from the oxide semiconductor layer 124a, the oxide semiconductor layer 124b, and the oxide semiconductor layer 124c.

In the case where a channel is mainly formed in the oxide semiconductor layer 124b, for example, an oxide containing a large amount of In can be used for the oxide semiconductor layer 124b and the pair of electrodes 105a and 105b is provided in contact with the oxide semiconductor layer 124b; thus, the on-state current of the transistor 120 can be increased.

### <Another Structural Example of Transistor>

A structural example of a top-gate transistor to which the oxide semiconductor film of one embodiment of the present invention can be applied is described below.

Note that descriptions of components having structures or functions similar to those of the above, which are denoted by the same reference numerals, are omitted below.

### Structural Example

FIG. 12A is a schematic cross-sectional view of a top-gate transistor 150 which is described below as an example.

The transistor 150 includes the oxide semiconductor layer 104 provided over the substrate 101 on which an insulating layer 151 is provided, the pair of electrodes 105a and 105b in contact with the top surface of the oxide semiconductor layer 104, the insulating layer 103 provided over the oxide semiconductor layer 104 and the pair of electrodes 105a and 105b, and the gate electrode 102 provided over the insulating layer 103 to overlap with the oxide semiconductor layer 104. Further, an insulating layer 152 is provided to cover the insulating layer 103 and the gate electrode 102.

The oxide semiconductor film described in Embodiment 6 can be applied to the oxide semiconductor layer 104 in the transistor 150.

The insulating layer 151 has a function of suppressing diffusion of impurities from the substrate 101 to the oxide semiconductor layer 104. For example, a structure similar to that of the insulating layer 107 can be employed. Note that the insulating layer 151 is not necessarily provided.

The insulating layer 152 can be formed using an insulating film having a blocking effect against oxygen, hydrogen, water, and the like in a manner similar to that of the insulating layer 107. Note that the insulating layer 107 is not necessarily provided.

### Modification Example

Structural examples of transistors which are partly different from the transistor 150 are described below.

FIG. 12B is a schematic cross-sectional view of a transistor 160 described as an example below. The transistor 160 is different from the transistor 150 in the structure of an oxide semiconductor layer.

In an oxide semiconductor layer 164 included in the transistor 160, an oxide semiconductor layer 164a, an oxide semiconductor layer 164b, and an oxide semiconductor layer 164c are stacked in this order.

The oxide semiconductor film of one embodiment of the present invention can be applied to at least one of the oxide semiconductor layer 164a, the oxide semiconductor layer 164b, and the oxide semiconductor layer 164c.

The oxide semiconductor layer 164b can have a structure which is similar to that of the oxide semiconductor layer 114a described as an example in Modification Example 1, for example. Further, the oxide semiconductor layers 164a and 164c can each have a structure which is similar to that of the oxide semiconductor layer 114b described as an example in Modification Example 1, for example.

An oxide containing a large amount of Ga that serves as a stabilizer is used for the oxide semiconductor layer 124a, which is provided under the oxide semiconductor layer 164b, and the oxide semiconductor layer 164c, which is provided over the oxide semiconductor layer 164b, for example; thus, oxygen can be prevented from being released from the oxide semiconductor layer 164a, the oxide semiconductor layer 164b, and the oxide semiconductor layer 164c.

The oxide semiconductor layer 164 can be formed in the following manner: the oxide semiconductor layer 164c and the oxide semiconductor layer 164b are obtained by etching, so that an oxide semiconductor film to be the oxide semiconductor layer 164a is exposed; and the oxide semiconductor film is processed into the oxide semiconductor layer 164a by a dry etching method. In that case, a reaction product of the oxide semiconductor film is attached to side surfaces of the oxide semiconductor layers 164b and 164c to form a sidewall protective layer (also referred to as a rabbit ear) in some cases. Note that the reaction product may be attached by a sputtering phenomenon or through plasma at the time of the dry etching.

FIG. 12C is a schematic cross-sectional view of a transistor 160 in which a sidewall protective layer 164d is formed as a side surface of the oxide semiconductor layer 164 in the above manner.

The sidewall protective layer 164d mainly contains the same material as the oxide semiconductor layer 164a. In some cases, the sidewall protective layer 164d contains the constituent (e.g., silicon) of a layer provided below the oxide semiconductor layer 164a (the insulating layer 151 here).

With a structure in which a side surface of the oxide semiconductor layer 164b is covered with the sidewall protective layer 164d so as not to be in contact with the pair of electrodes 105a and 105b as illustrated in FIG. 12C, unintended leakage current of the transistor in an off state can be reduced particularly when a channel is mainly formed in the oxide semiconductor layer 164b; thus, a transistor having favorable off-state characteristics can be fabricated. Further, when a material containing a large amount of Ga that serves as a stabilizer is used for the sidewall protective layer 164d, oxygen can be effectively prevented from being released from the side surface of the oxide semiconductor layer 164b; thus, a transistor having excellent stability of electrical characteristics can be fabricated.

This embodiment can be combined with any of the other embodiments disclosed in this specification as appropriate.

### Embodiment 8

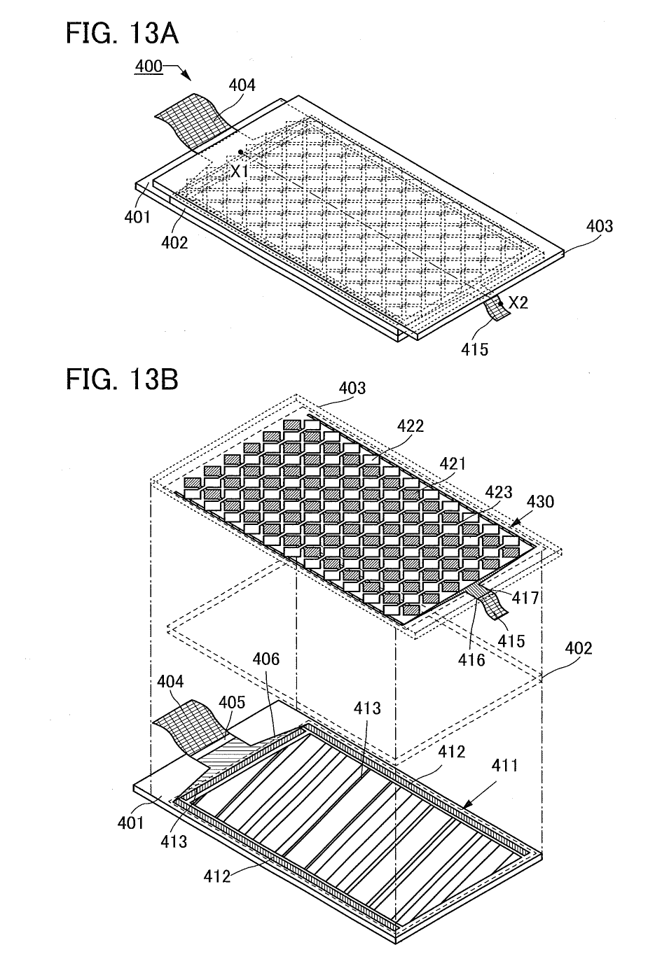

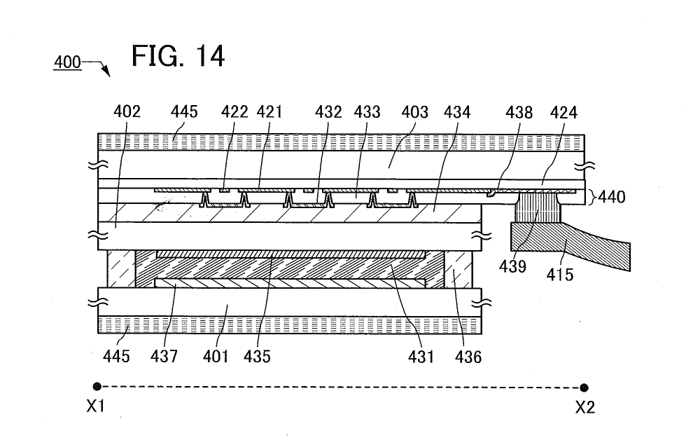

In this embodiment, a structure of a touch panel in which a touch sensor (a contact detection device) as an input unit is provided to overlap with a display portion is described with reference to FIGS. 13A and 13B and FIG. 14. Hereinafter, the description of the same portions as the above embodiments is omitted in some cases.

FIG. 13A is a schematic perspective view of a touch panel 400 described in this embodiment as an example. Note that FIGS. 13A and 13B illustrate only main components for simplicity. FIG. 13B is a developed view of the schematic perspective view of the touch panel 400.

FIG. 14 is a cross-sectional view of the touch panel 400 taken along X1-X2 in FIG. 13A.

The touch panel 400 includes a display portion 411 sandwiched between a first substrate 401 and a second substrate 402 and a touch sensor 430 sandwiched between the second substrate 402 and a third substrate 403.

The first substrate 401 is provided with the display portion 411 and a plurality of wirings 406 electrically connected to the display portion 411. The plurality of wirings 406 are led to the outer edge portion of the first substrate 401, and part of the wirings 406 forms part of an external connection electrode 405. The external connection electrode 405 is electrically connected to an FPC 404.

### <Touch Sensor>

The third substrate 403 is provided with the touch sensor 430 and a plurality of wirings 417 electrically connected to the touch sensor 430. The touch sensor 430 is provided on a surface of the third substrate 403 on a side facing the second substrate 402. The plurality of wirings 417 is led to the periphery of the third substrate 403, and part of the wirings forms part of an external connection electrode 416 for electrical connection to an FPC 415. Note that in FIG. 13B, electrodes, wirings, and the like of the touch sensor 430 which are provided on the back side of the third substrate 403 (the back side of the diagram) are indicated by solid lines for clarity.

In this embodiment, a projected capacitive touch sensor is used. However, one embodiment of the present invention is not limited thereto. It is also possible to use a sensor which senses proximity or touch of an object, such as a finger, on the side opposite to the side provided with display elements.

As a sensor layer of a touch sensor, a capacitive touch sensor is preferably used. Examples of the capacitive touch sensor are of a surface capacitive type, of a projected capacitive type, and the like. Further, examples of the projected capacitive type are of a self capacitive type, a mutual capacitive type, and the like mainly in accordance with the difference in the driving method. The use of a mutual capacitive type is preferable because multiple points can be sensed simultaneously.

The case of using a projected capacitive touch sensor is described below.

The touch sensor 430 illustrated in FIG. 13B is an example of a projected capacitive touch sensor. The touch sensor 430 includes electrodes 421 and electrodes 422. The electrode 421 and the electrode 422 are each electrically connected to any one of the plurality of wirings 417.

Here, the electrode 422 is in the form of a series of quadrangles arranged in one direction as illustrated in FIGS. 13A and 13B. Each of the electrodes 421 is in the form of a quadrangle. The plurality of electrodes 421 arranged in a line in a direction intersecting with the direction in which the electrode 422 extends is electrically connected to each other by the wiring 423. The electrode 422 and the wiring 423 are preferably arranged so that the area of the intersecting portion of the electrode 422 and the wiring 423 becomes as small as possible. Such a shape can reduce the area of a region where the electrodes are not provided and decrease luminance unevenness of light passing through the touch sensor 430 which are caused by a difference in transmittance depending on whether the electrodes are provided or not.

Note that the shapes of the electrode 421 and the electrode 422 are not limited thereto and can be any of a variety of shapes. For example, a structure may be employed in which the plurality of electrodes 421 are arranged so that gaps between the electrodes 421 are reduced as much as possible, and the electrode 422 is spaced apart from the electrodes 421 with an insulating layer interposed therebetween to have regions not overlapping with the electrodes 421. In that case, between two adjacent electrodes 422, it is preferable to provide a dummy electrode which is electrically insulated from these electrodes, whereby the area of regions having different transmittances can be reduced.

The structure of the touch sensor 430 is described with reference to FIG. 14.

The touch sensor is provided over the second substrate 402. In the touch sensor, a sensor layer 440 is provided on one surface of the third substrate 403 with an insulating layer 424 placed therebetween and is bonded to the second substrate 402 with a bonding layer 434.

The sensor layer 440 is found over the third substrate 403, and then attached to the second substrate 402 with the bonding layer 434. With such a method, a touch sensor is overlapped with a display panel, whereby a touch panel can be formed.

For the insulating layer 424, an oxide such as a silicon oxide can be used. Electrodes 421 having a light-transmitting property and electrodes 422 having a light-transmitting property are provided in contact with the insulating layer 424. The electrodes 421 and 422 are formed in such a manner that a conductive film is formed by sputtering over the insulating layer 424 formed over the third substrate 403 and then unnecessary portions of the conductive film are removed by a known patterning technique such as photolithography. As a light-transmitting conductive material, a conductive oxide such as indium oxide, indium tin oxide, indium zinc oxide, zinc oxide, or zinc oxide to which gallium is added can be used.

A wiring 438 is electrically connected to the electrode 421 or the electrode 422. Part of the wiring 438 serves as an external connection electrode which is electrically connected to the FPC 415. For the wiring 438, a metal material such as aluminum, gold, platinum, silver, nickel, titanium, tungsten, chromium, molybdenum, iron, cobalt, copper, or palladium or an alloy material containing any of these metal materials can be used.

The electrodes 422 are provided to form stripes extended in one direction. The electrodes 421 are arranged so that one electrode 422 is placed between a pair of electrodes 421. A wiring 432 that electrically connects the electrodes 421 is provided to cross the electrode 422. Here, one electrode 422 and a plurality of electrodes 421 electrically connected to each other by the wiring 432 do not necessarily cross orthogonally and may form an angle of less than 90°.

An insulating layer 433 is provided to cover the electrodes 421 and the electrodes 422. As a material of the insulating layer 433, for example, a resin such as acrylic or epoxy, a resin having a siloxane bond, or an inorganic insulating material such as silicon oxide, silicon oxynitride, or aluminum oxide can be used. An opening reaching the electrode 421 is formed in the insulating layer 433, and the wiring 432, which is electrically connected to the electrode 421, is provided in the opening. The wiring 432 is preferably formed using a light-transmitting conductive material similar to that of the electrodes 421 and 422, in which case the aperture ratio of the touch panel can be increased. Although the wiring 432 may be formed using the same material as the electrodes 421 and 422, it is preferably formed using a material having higher conductivity than the material of the electrodes 421 and 422.

An insulating layer that covers the insulating layer 433 and the wiring 432 may be provided. The insulating layer can serve as a protection layer.

An opening reaching the wiring 438 is formed in the insulating layer 433 (and the insulating layer serving as a protection layer). A connection layer 439 provided in the opening electrically connects the FPC 415 with the wiring 438. For the connection layer 439, an anisotropic conductive film (ACF), anisotropic conductive paste (ACP), or the like can be used.

It is preferable that the adhesive layer 434 by which the sensor layer 440 is bonded to the second substrate 402 have a light-transmitting property. For example, a thermosetting resin or an ultraviolet curable resin can be used; specifically, a resin such as an acrylic resin, an urethane resin, an epoxy resin, or a resin having a siloxane bond can be used.

### <Display Portion>

The display portion 411 includes a pixel portion 413 including a plurality of pixels. As a display element that can be used in the pixel portion 413 of the display portion 411, any of a variety of display elements such as an organic EL element, a liquid crystal element, and a display element performing display with electrophoresis, electronic liquid powder, or the like can be used.

The case where a liquid crystal element is used as a display element is described below.

A liquid crystal 431 is sealed between the first substrate 401 and the second substrate 402 with a sealant 436. The sealant 436 is provided to surround a switching element layer 437 and a color filter layer 435.

As the sealant 436, a thermosetting resin or an ultraviolet curable resin can be used; for example, an organic resin such as an acrylic resin, an urethane resin, an epoxy resin, or a resin having a siloxane bond can be used. Alternatively, the sealant 436 may be formed with glass fit including a low-melting-point glass. Further alternatively, the sealant 436 may be formed with a combination of the organic resin and the glass frit. For example, a structure in which the organic resin is provided in contact with the liquid crystal 431 and the glass frit is provided outside the resin can prevent water and the like from entering the liquid crystal from the outside.

The display portion 411 includes a source driver circuit 412s and a gate driver circuit 412g and is sealed between the first substrate 401 and the second substrate 402 together with the liquid crystal 431.

Although two source driver circuits 412s are positioned on respective opposite sides of the pixel portion 413 in FIG. 13B, one source driver circuit 412s may be positioned along one side of the pixel portion 413.

The switching element layer 437 is provided over the first substrate 401 (see FIG. 14). The switching element layer 437 includes at least a transistor, and may include an element such as a capacitor in addition to the transistor. Note that the switching element layer 437 may also include a circuit such as a driver circuit (a gate driver circuit or a source driver circuit), a wiring, an electrode, or the like.

A color filter layer 435 is provided on one surface of the second substrate 402. The color filter layer 435 includes a color filter which overlaps with a liquid crystal element. When the color filter layer 435 is provided with three color filters of red (R), green (G), and blue (B), a full-color liquid crystal panel can be obtained.

The color filter layer 435 can be formed using a photosensitive material including a pigment by a photolithography process. As the color filter layer 435, a black matrix may be provided between color filters with different colors. Furthermore, an overcoat may be provided to cover the color filters and the black matrix.

Note that one of electrodes of the liquid crystal element may be formed on the color filter layer 435 in accordance with the structure of the liquid crystal element. Note that the electrode becomes part of the liquid crystal element to be formed later. An alignment film may be provided over the electrode.

A pair of polarizing plates 445 is provided to sandwich the liquid crystal 431. Specifically, the first substrate 401 and the third substrate 403 are provided with the respective polarizing plates 445.

The polarizing plate 445 is a known polarizing plate and is formed using a material capable of producing linearly polarized light from natural light or circularly polarized light. For example, a material whose optical anisotropy is obtained by disposing dichroic substances in one direction can be used. Such a polarizing plate can be formed in such a manner that an iodine-based compound or the like is adsorbed to a film such as a polyvinyl alcohol film and the film or the like is stretched in one direction, for example. Note that as the dichroic substance, a dye-based compound or the like as well as an iodine-based compound can be used. A film-like, sheet-like, or plate-like material can be used for the polarizing plate 445.

This embodiment can be combined with any of the other embodiments disclosed in this specification as appropriate.

### Embodiment 9

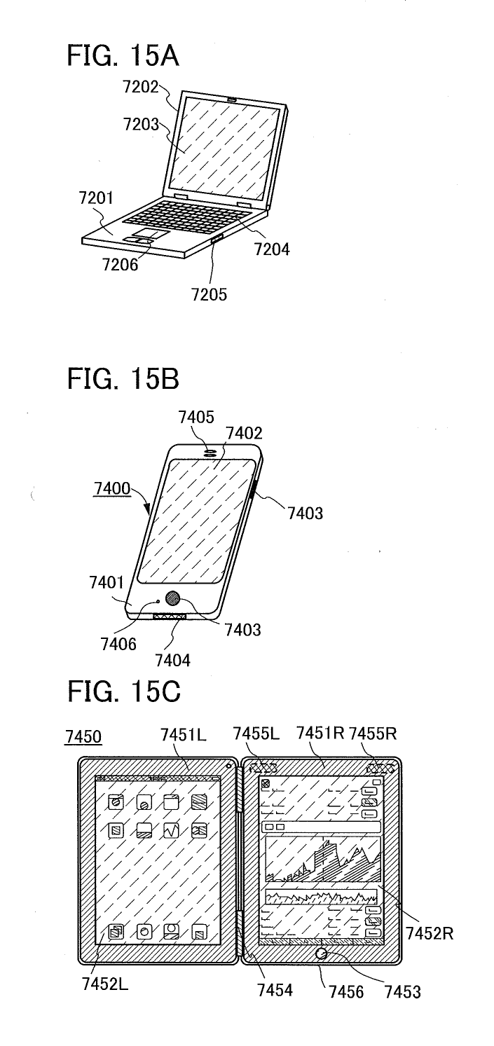

In this embodiment, electronic devices of one embodiment of the present invention are described. Specifically, electronic devices of one embodiment of the present invention each includes an arithmetic unit, an input unit for inputting information to the arithmetic unit, a display portion which includes a plurality of pixels for displaying information processed in the arithmetic unit at a resolution of 150 ppi or more and which is capable of eye-friendly display by using light which does not include light with a wavelength shorter than 420 nm, and a storage unit which stores a program executed by the arithmetic unit are described with reference to FIGS. 15A to 15C.

Examples of electronic devices of one embodiment of the present invention are computers, cameras such as digital cameras and digital video cameras, digital photo frames, cellular phones (also referred to as mobile phones or portable telephone devices), portable information terminals, audio playback devices, and the like. Specific examples of these electronic devices are illustrated in FIGS. 15A to 15C.

FIG. 15A illustrates a computer, which includes a main body 7201, a housing 7202, a display portion 7203, a keyboard 7204, an external connecting port 7205, a pointing device 7206, and the like. Note that the computer displays the results of processing by an arithmetic device on the display portion 7203.

FIG. 15B illustrates an example of a cellular phone. A cellular phone 7400 is provided with a display portion 7402 incorporated in a housing 7401, operation buttons 7403, an external connection port 7404, a speaker 7405, a microphone 7406, and the like. Note that the cellular phone 7400 displays the results of processing by an arithmetic device on the display portion 7402.

When the display portion 7402 of the cellular phone 7400 illustrated in FIG. 15B is touched with a finger or the like, data can be input into the cellular phone 7400. Further, operations such as making a call and creating an e-mail can be performed by touching the display portion 7402 with a finger or the like.

There are mainly three screen modes of the display portion 7402. The first mode is a display mode mainly for displaying an image. The second mode is an input mode mainly for inputting data such as characters. The third mode is a display-and-input mode in which two modes of the display mode and the input mode are combined.

For example, in the case of making a call or creating e-mail, a character input mode mainly for inputting characters is selected for the display portion 7402 so that characters displayed on the screen can be input. In this case, it is preferable to display a keyboard or number buttons on almost the entire screen of the display portion 7402.

When a detection device including a sensor for detecting inclination, such as a gyroscope or an acceleration sensor, is provided inside the cellular phone 7400, display on the screen of the display portion 7402 can be automatically changed by determining the orientation of the cellular phone 7400 (whether the cellular phone is placed horizontally or vertically for a landscape mode or a portrait mode).

The screen modes are switched by touching the display portion 7402 or operating the operation buttons 7403 of the housing 7401. The screen modes can be switched depending on the kind of images displayed on the display portion 7402. For example, when a signal of an image displayed on the display portion is a signal of moving image data, the screen mode is switched to the display mode. When the signal is a signal of text data, the screen mode is switched to the input mode.

Moreover, in the input mode, if a signal detected by an optical sensor in the display portion 7402 is detected and the input by touch on the display portion 7402 is not performed for a certain period, the screen mode may be controlled so as to be changed from the input mode to the display mode.

The display portion 7402 may function as an image sensor. For example, an image of a palm print, a fingerprint, or the like is taken by touch on the display portion 7402 with the palm or the finger, whereby personal authentication can be performed.

Further, by providing a backlight or a sensing light source which emits a near-infrared light in the display portion, an image of a finger vein, a palm vein, or the like can be taken.

FIG. 15C illustrates an example of a folding computer. A folding computer 7450 includes a housing 7451L and a housing 7451R connected by hinges 7454. The computer 7450 further includes an operation button 7453, a left speaker 7455L, and a right speaker 7455R. In addition, a side surface of the computer 7450 is provided with an external connection port 7456, which is not illustrated. Note that when the computer 7450 is folded on the hinges 7454 so that a display portion 7452L provided in the housing 7451L and a display portion 7452R provided in the housing 7451R can face each other, the display portions can be protected by the housings.

Each of the display portions 7452L and 7452R is a component which can display images and to which data can be input by touch with a finger or the like. For example, the icon for the installed program is selected by touch with a finger, so that the program can be started. Further, changing the distance between fingers touching two positions of the displayed image enables zooming in or out on the image. Drag of a finger touching one position of the displayed image enables drag and drop of the image. Selection of the displayed character or symbol on the displayed image of a keyboard by touch with a finger enables information input.

Further, the computer 7450 can also include a gyroscope, an acceleration sensor, a global positioning system (GPS) receiver, fingerprint sensor, or a video camera. For example, when a detection device including a sensor for detecting inclination, such as a gyroscope or an acceleration sensor, is provided, the orientation of the display screen can be automatically changed by determining the orientation of the computer 7450 (whether the computer 7450 is placed horizontally or vertically).

Furthermore, the computer 7450 can be connected to a network. The computer 7450 not only can display data on the Internet but also can be used as a terminal which controls another electronic device connected to the network from a distant place.

This embodiment can be combined with any of the other embodiments in this specification as appropriate.

This application is based on Japanese Patent Application serial no. 2013-038218 filed with Japan Patent Office on Feb. 28, 2013, the entire contents of which are hereby incorporated by reference.

What is claimed is:

1. A method for displaying image information, comprising:
a first step of displaying image information including a character string on a display portion by using light with a wavelength greater than or equal to 420 nm, the display portion including a plurality of pixels with a resolution of 150 ppi or more;
a second step of selecting a first region including the character string; and
a third step of enlarging and displaying the character string in a second region which is larger than the first region.

2. The method for displaying image information, according to claim 1, further comprising:
a fourth step of bringing the first region into a non-selected state; and
a fifth step of erasing display of the character string from the second region.

3. The method for displaying image information, according to claim 1,
wherein a plain image is displayed on the second region as a background of the character string.

4. The method for displaying image information, according to claim 1,
wherein the first region includes a row to which the character string belongs and rows before and after the row to which the character string belongs.

5. The method for displaying image information, according to claim 1,
wherein in the third step, the second region is located so as to partly overlap with or be adjacent to the first region.

6. The method for displaying image information, according to claim 2,
wherein in the fourth step, the first region is brought into a non-selected state by selecting a region other than both of the first region and the second region.

7. The method for displaying image information, according to claim 1, further comprising:
a step of specifying one user in accordance with positions of users with respect to the display portion,
wherein in the second step, the first region including the character string is selected by using a sight line of the one user.

8. The method for displaying image infatuation, according to claim 7, further comprising:
a fourth step of bringing the first region into a non-selected state; and
a fifth step of erasing display of the character string from the second region.

9. A storage unit storing a program for making an information processor execute a process,
wherein the information processor includes a display portion which includes a plurality of pixels at a resolution of 150 ppi or more, and
wherein the process comprising:
a first step of displaying image information including a character string on the display portion by using light with a wavelength greater than or equal to 420 nm;
a second step of selecting a first region including the character string; and
a third step of enlarging and displaying the character string in a second region which is larger than the first region.

10. The storage unit according to claim 9,
wherein the process further comprises:
a fourth step of bringing the first region into a non-selected state; and
a fifth step of erasing display of the character string from the second region.

11. The storage unit according to claim 9,
wherein a plain image is displayed on the second region as a background of the character string.

12. The storage unit according to claim 9,
wherein the first region includes a row to which the character string belongs and rows before and after the row to which the character string belongs.

13. An information processor comprising:
an arithmetic unit configured to execute a process;
an input unit capable of inputting information to the arithmetic unit; and
a display portion which includes a plurality of pixels at a resolution of 150 ppi or more,
wherein the process comprises:
a first step of displaying image information including a character string on the display portion by using light with a wavelength greater than or equal to 420 nm;
a second step of selecting a first region including the character string; and
a third step of enlarging and displaying the character string in a second region which is larger than the first region.

14. The information processor according to claim 13,
wherein the process further comprises:
a fourth step of bringing the first region into a non-selected state; and
a fifth step of erasing display of the character string from the second region.

15. The information processor according to claim 13,
wherein a plain image is displayed on the second region as a background of the character string.

16. The information processor according to claim 13,
wherein the first region includes a row to which the character string belongs and rows before and after the row to which the character string belongs.
